(19) United States
(12) Patent Application Publication
(10) Pub. No.: US 2022/0279511 A1
(43) Pub. Date: Sep. 1, 2022

(54) FLEXIBLE UTILIZATION OF COMMUNICATION RESOURCES TO SUPPORT BOTH ACCESS AND BACKHAUL

(71) Applicant: SHARP KABUSHIKI KAISHA, Sakai City, Osaka (JP)

(72) Inventors: JOHN MICHAEL KOWALSKI, Vancouver, WA (US); KAZUNARI YOKOMAKURA, Sakai City, Osaka (JP)

(21) Appl. No.: 17/625,535

(22) PCT Filed: Jul. 9, 2020
(86) PCT No.: PCT/JP2020/026926

§ 371 Date: Jan. 7, 2022

Related U.S. Application Data
(60) Provisional application No. 62/872,636, filed on Jul. 10, 2019.

(51) Int. Cl. H04W 72/04

(52) U.S. Cl. CPC H04W 72/0426; H04W 72/0446; H04W 88/14

(57) ABSTRACT

A parent Integrated Access and Backhaul (IAB) node that communicates over a radio interface, the parent IAB node comprises processor circuitry resource configuration information for use by one or more child IAB nodes. The transmitter circuitry is configured to transmit the radio resource configuration information to the child IAB node.

### TECHNICAL FIELD

The technology relates to wireless communications, and particularly to allocation of radio resources for on wireless backhaul links.

### BACKGROUND ART

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and g-UTRAN, the New Radio (NR) .

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNodeB” or “eNB”), a home eNB (“HeNB”), a “gNodeB” or “gNB” for a New Radio [“NR”] technology system, or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth generation system, e.g., the 5G System, also called “NR” or “New Radio”, as well as “NG” or “Next Generation”, is shown in FIG. 1, and is also described in 3GPP TS 38.300. The 5G NR network is comprised of NG RAN (Next Generation Radio Access Network) and 5GC (5G Core Network). As shown, NGRAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. ANG interface exists between 5GC and the base stations (i.e. gNB & ng-eNB). A gNB node provides NR user plane and control plane protocol terminations towards the UE, and is connected via the NG interface to the 5GC. The 5G NR (New Radio) gNB is connected to AMF (Access and Mobility Management Function) and UPF (User Plane Function) in 5GC (5G Core Network).

In some cellular mobile communication systems and networks, such as Long-Term Evolution (LTE) and New Radio (NR), a service area is covered by one or more base stations, where each of such base stations may be connected to a core network by fixed-line backhaul links (e.g., optical fiber cables). In some instances, due to weak signals from the base station at the edge of the service area, users tend to experience performance issues, such as: reduced data rates, high probability of link failures, etc. A relay node concept has been introduced to expand the coverage area and increase the signal quality. As implemented, the relay node may be connected to the base station using a wireless backhaul link.

In 3rd Generation Partnership Project (3GPP), the relay node concept for the fifth generation (5G) cellular system has been discussed and standardized, where the relay nodes may utilize the same 5G radio access technologies (e.g., New Radio (NR)) for the operation of services to User Equipment (UE) (access link) and connections to the core network (backhaul link) simultaneously. These radio links may be multiplexed in time, frequency, and/or space. This system may be referred to as Integrated Access and Backhaul (IAB).

Some such cellular mobile communication systems and networks may comprise IAB-donors and IAB-nodes, where an IAB-donor may provide interface to a core network to UEs and wireless backhauling functionality to IAB-nodes; and additionally, an IAB-node may provide IAB functionality combined with wireless self-backhauling capabilities.

RANI #97 discussions have concerned, e.g., Integrated Access and Backhaul (IAB) resource utilization and timing differences among IAB nodes. It has been recognized that signaling on an IAB network needs to take into account the fact that in general there will be timing differences associated the timing references present in an IAB network. In conjunction with such RANI #97 discussions, R1-1907117 has proposed puncturing of an IAB's DU transmission symbols to allow the node's MT to receive. See, e.g., R1-1907117, Open items with IAB Case #1 timing, Nokia, Nokia Shanghai B. Other issues with resource allocation that are left unaddressed.

A difference between an IAB network and a “traditional” radio access network (RAN) is that a client device, e.g., a UE or user equipment, in a “traditional” RAN is essentially a slave of the gNB. For example, in a traditional RAN the timing of the client device is controlled and exists at the mercy of the gNB(s) to which the UEs is connected. However, IAB nodes are in effect an essentially passive aggressive peer/not peer network. An IAB node may be either a Donor IAB Node or a non-Donor IAB Node.

A Donor IAB Node is a node that provides access of core network/backhaul/radio resource control functionality to the IAB network. A Donor IAB node may comprise a CU, e.g., a “Central Unit,” or more properly, a gNB-CU, and a distributed unit, e.g., DU. The central unit CU is “a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU” according to 3GPP TS38.401.

A non-Donor IAB node may either be a relay IAB node or a client device, e.g., a wireless terminal or UE. A relay IAB mode may comprise a mobile termination unit, MT, and a distributed unit, DU. An IAB node that is a wireless terminal or mobile device may comprise transceiver circuitry, e.g., a transmitter and received, and processor circuitry.

FIG. 2 illustrates an example of a timing difference between mobile termination timing, e.g., MT timing, and distributed unit timing, e.g., DU timing, in a single IAB node. Such a timing difference, t_{b}, which may be unresolvable to zero, may occur, for example, in situations where an IAB network has multiplepoints/instances of synchronization that may be provided by GNSS (Global Navigation Satellite Systems) or GNSS equivalent, e.g., terrestrial based, “black box” Ce 137 accurate timing assisted, etc., systems to multiple IAB nodes. Thus, for example for IAB Node 1 in FIG. 2, a “Generation 1” timing between MT of IAB Node 1 and the CU entity in the Donor Node differs from a “Generation 2” timing between DU of IAB Node 1 and the MT of IAB Node 2 by t_{b} seconds.

What is needed are methods, apparatus, and/or techniques which involve or facilitate signaling and/or measurements that allow for indication of time delay and for when a given resource can be made available.

### SUMMARY OF INVENTION

In one example, a parent Integrated Access and Backhaul (IAB) node that communicates over a radio interface, the parent IAB node comprising: processor circuitry configured to generate radio resource configuration information to take into consideration a switching time characteristic of a child IAB node; receiver circuitry configured to receive the capability of the switching time characteristic from the child IAB node; and transmitter circuitry configured to transmit the radio resource configuration information to the child IAB node.

In one example, a method in a parent Integrated Access and Backhaul (IAB) node that communicates over a radio interface, the method comprising: obtaining a switching time characteristic information for the child IAB node; generating radio resource configuration information to take into consideration a switching time characteristic of a child IAB node; transmitting the radio resource configuration information to the child IAB node.

In one example, a child Integrated Access and Backhaul (IAB) node that communicates over a radio interface with a parent IAB node, the child IAB node comprising: transmitter circuitry configured to transmit a capability of a switching time characteristics; receiver circuitry configured to receive radio resource configuration information from the parent node, processor circuitry configured to control wireless communications of the child IAB node in accordance with the radio resource configuration information.

In one example, a method in a child Integrated Access and Backhaul (IAB) node that communicates over a radio interface with a parent IAB node, the method comprising: receiving radio resource configuration information from the parent node, the radio resource configuration information being configured to take into consideration a switching time characteristic of the child IAB node; controlling wireless communications of the child IAB node in accordance with the radio resource configuration information.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a diagrammatic view showing an example of a timing difference between a parent and child link of an IAB node.

FIG. 3 is a diagrammatic view illustrating a mobile network infrastructure using 5G signals and 5G base stations, and particularly showing a donor IAB node comprising an IAB resource configuration controller and plural IAB nodes each comprising an IAB resource configuration manager.

FIG. 4 is a diagrammatic view depicting an example of functional block diagrams for donor IAB node and a representative IAB node of FIG. 3.

FIG. 5 is a schematic view of an example generic communication system comprising an Integrated Access and Backhaul (IAB) network.

FIG. 6 is a schematic view of portions of a first example communication system comprising an Integrated Access and Backhaul (IAB) network and wherein resource allocation takes into consideration a switching time characteristic of a child IAB node.

FIG. 7 is a schematic view of portions of a second example communication system comprising an Integrated Access and Backhaul (IAB) network and wherein resource allocation takes into consideration a switching time characteristic of a child IAB node.

FIG. 8 is a flowchart showing example, non-limiting, basic acts or steps that may be performed by a parent IAB node of FIG. 6 and FIG. 7.

FIG. 9 is a flowchart showing example, non-limiting, basic acts or steps that may be performed by a child IAB node of FIG. 6 and FIG. 7.

FIG. 10 is a schematic view of portions of an example communication system comprising an Integrated Access and Backhaul (IAB) network and wherein resource allocation takes into consideration a first resource constraint.

FIG. 11 is a schematic view of portions of an example communication system comprising an Integrated Access and Backhaul (IAB) network and wherein a child IAB node signals, to a central unit of a donor IAB node, the resources delegated to a distributed unit of the child IAB node.

FIG. 12 is a schematic view of portions of an example communication system comprising an Integrated Access and Backhaul (IAB) network and allocation of radio resources uses a coincidence prohibition constraint.

FIG. 13 is a schematic view of portions of an example communication system comprising an Integrated Access and Backhaul (IAB) network and wherein a central unit of a donor IAB node sends association signal to a child IAB node.

FIG. 14 is a schematic view of portions of an example communication system comprising an Integrated Access and Backhaul (IAB) network and wherein a resource/parent association signal specifies which resources are under the control of which parents.

FIG. 15 is a schematic view of portions of an example communication system comprising an Integrated Access and Backhaul (IAB) network and wherein an IAB resource configuration manager of a child IAB node 24 has access to flexible allocations of plurality of MT's flexible resources.

FIG. 16 is a diagrammatic view of an UL RRC message which may be carried in an RRC-Container IE encapsulated in an F1 message uplink that may be used for indicating Child DU allocated resources.

FIG. 17 is a diagrammatic view of downlink signaling which may be used in the case of (re)configuration of resources for (re)association of resources between DU-S and MT-F resources.

FIG. 18 is a diagrammatic view showing example elements comprising electronic machinery which may comprise a wireless terminal, a radio access node, and a core network node according to an example embodiment and mode.

### DESCRIPTION OF EMBODIMENTS

A parent Integrated Access and Backhaul (IAB) node that communicates over a radio interface, the parent IAB node comprises processor circuitry and transmitter circuitry. The processor circuitry is configured to generate radio resource configuration information for use by one or more child IAB nodes. The transmitter circuitry is configured to transmit the radio resource configuration information to the child IAB node. In some example embodiments and modes, the resource configuration information takes into consideration a switching time characteristic of the child IAB node. In some example embodiments and modes, the resource configuration information alternatively or additionally assigns a first resource as a soft distributed unit resource to the child IAB node, but does not allow the child IAB node to communicate in the first resource. In some example embodiments and modes, the resource configuration information alternatively or additionally does not schedule a transmission to the child IAB node if the transmission were to coincide with a transmission from the child IAB node. In some example embodiments and modes, the resource configuration information signals to the child IAB node an association between soft resources of a distributed unit of the child IAB node and flexible resource of a mobile termination unit of the child IAB node. In some example embodiments and modes, the resource configuration information informs which resources are under control of which parents. Also disclosed are (1) methods of operating such parent IAB nodes, (2) example embodiments and modes of child IAB nodes which communicate with and receive the resource configuration information, and (3) methods of operating such child IAB nodes.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B or “NB”, an enhanced Node B or eNodeB or eNB, a home eNB (“HeNB”), a gnodeB or gNB for a New Radio [“NR”] technology system, or some other similar terminology.

As used herein, the term “telecommunication system” or “communications system” can refer to any network of devices used to transmit information. A non-limiting example of a telecommunication system is a cellular network or other wireless communication system. Furthermore, the “node” may comprise a portion of a gNB's architecture, in particular, a gNB-DU (gNB Distributed Unit), which would be a logical node hosting RLC, MAC and PHY layers of the gNB, under the control of a gNB-CU (gNB Central Unit), which would reside in a “donor node,” and hosting RRC, SDAP and PDCP protocols of the gNB or RRC and PDCP protocols of the en-gNB that controls the operation of one or more gNB-DUs.

As used herein, the term “cellular network” or “cellular radio access network” can refer to a network distributed over cells, each cell served by at least one fixed-location transceiver, such as a base station. It should also be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources.

A cellular network using licensed frequency bands can include configured cells.

Configured cells can include cells of which a UE terminal is aware and in which it is allowed by a base station to transmit or receive information. Examples of cellular radio access networks include E-UTRAN, and any successors thereof (e.g., NUTRAN).

Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

Any reference to a “resource” herein means “radio resource” unless otherwise clear from the context that another meaning is intended. In general, as used herein a radio resource (“resource”) is a time-frequency unit that can carry information across a radio interface, e.g., either signal information or data information. An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two dimensional grid represents a symbol (e.g., an OFDM symbol on downlink (DL) from node to wireless terminal; an SCFDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k,l) in a slot (where k and 1 are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural sub-carriers and plural symbols (e.g., plural resource elements (RE)) and is called a resource block (RB). A resource block may comprise, for example, 84 resource elements, i.e., 12 subcarriers and 7 symbols, in case of normal cyclic prefix.

A mobile network used in wireless networks may be where the source and destination are interconnected by way of a plurality of nodes. In such a network, the source and destination may not be able to communicate with each other directly due to the distance between the source and destination being greater than the transmission range of the nodes. That is, a need exists for intermediate node(s) to relay communications and provide transmission of information. Accordingly, intermediate node(s) may be used to relay information signals in a relay network, having a network topology where the source and destination are interconnected by means of such intermediate nodes. In a hierarchical telecommunications network, the backhaul portion of the network may comprise the intermediate links between the core network and the small subnetworks of the entire hierarchical network. Integrated Access and Backhaul (IAB) Next generation NodeB use 5G New Radio communications such as transmitting and receiving NR User Plane (U-Plane) data traffic and NR Control Plane (C-Plane) data. Both, the UE and gNB may include addressable memory in electronic communication with a processor. In one embodiment, instructions may be stored in the memory and are executable to process received packets and/or transmit packets according to different protocols, for example, Medium Access Control (MAC) Protocol and/or Radio Link Control (RLC) Protocol.

A. Generic Architecture Description

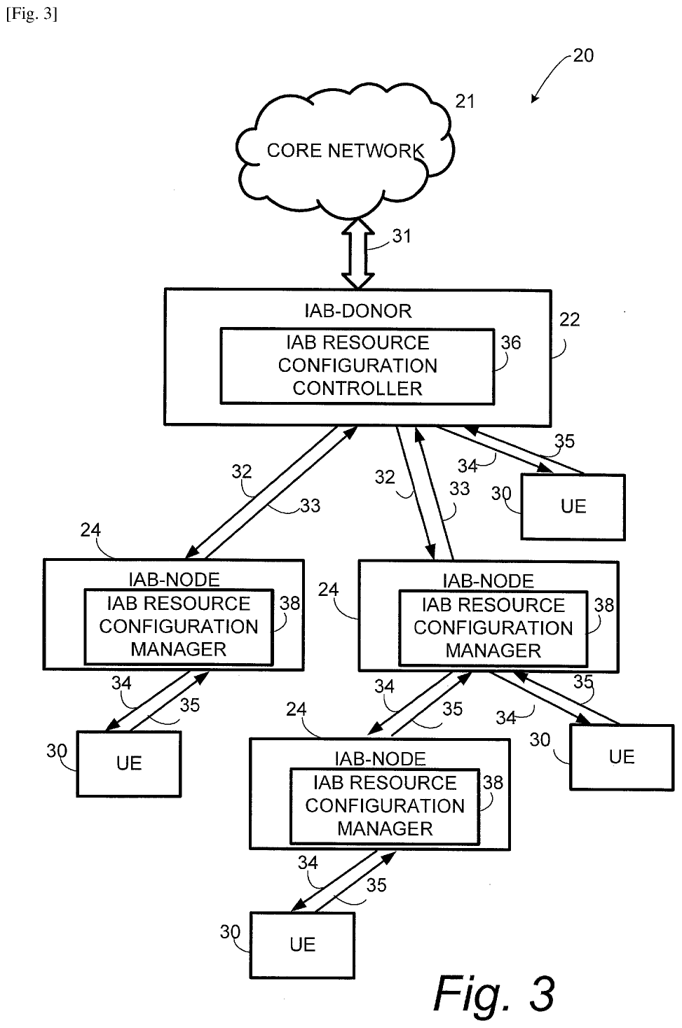

FIG. 3 shows an example telecommunications system 20 comprising core network 21 and plural wireless access nodes including donor or parent IAB node 22 and other IAB nodes 24 which are not donor IAB nodes; and plural user equipments (UE) 30 that are served by one or more of the access nodes. FIG. 3 further shows that the donor IAB node 22 may be connected to core network 21, e.g., by a wireline 31 or other suitable connection; and that wireless access links may connect the donor IAB node 22, the IAB nodes 24, and the user equipments (UEs) 30. FIG. 3 particularly shows, for example, that donor IAB node 22 is connected by downlink donor backhaul link 32 and uplink donor backhaul link 33 to one or more IAB nodes 24. FIG. 3 further shows that an IAB node 24 may be connected by downlink backhaul link 34 and uplink backhaul link 35 to one or more child nodes, e.g., to a user equipment (UE) 30 or to another IAB node 24. It should be understood that some parts of operations and behaviors that are performed by the donor IAB node may be able to be performed by a parent IAB node.

With reference to FIG. 3, the present embodiments include a mobile network infrastructure using 5G signals and 5G base stations (or cell stations). Depicted is a system diagram of a radio access network utilizing IAB nodes, where the radio access network may comprise, for example, one IAB-donor and multiple IAB-nodes. Different embodiments may comprise different number of IAB-donor and IAB-node ratios. Herein, the IAB nodes may be referred to as IAB relay nodes. The IAB-node may be a Radio Access Network (RAN) node that supports wireless access to UEs and wirelessly backhauls the access traffic. The IAB-donor may be a RAN node which may provide an interface to the core network to UEs and wireless backhauling functionality to IAB nodes. An IAB-node/donor may serve one or more IAB nodes using wireless backhaul links as well as UEs using wireless access links simultaneously. Accordingly, network backhaul traffic conditions may be implemented based on the wireless communication system to a plurality of IAB nodes and UEs.

With further reference to FIG. 3, plural UEs 30 are depicted as in communication with IAB nodes, for example, IAB nodes 24 and IAB donor node 22, via wireless access link(s). Additionally, the IAB-nodes (child nodes) may be in communication with other IAB-nodes and/or an IAB-donor (all of which may be considered IAB parent nodes) via wireless backhaul link. For example, a UE may be connected to an IAB-node which itself may be connected to a parent IAB-node in communication with an IAB-donor, thereby extending the backhaul resources to allow for the transmission of backhaul traffic within the network and between parent and child for integrated access. The embodiments of the system provide for capabilities needed to use the broadcast channel for carrying information bit(s) (on the physical channels) and provide access to the core network.

FIG. 3 further shows that the donor IAB node 22 comprises IAB resource configuration controller 36, and that the IAB nodes 24 each comprise IAB resource configuration manager 38. In certain example aspects of the technology disclosed herein, and as explained hereinafter in various differing example embodiments and modes, the IAB resource configuration controller 36 of donor IAB node 22, often working in conjunction with the IAB resource configuration managers 38 of the IAB nodes 24, facilitates enhanced and more efficient operation of the telecommunications system 20.

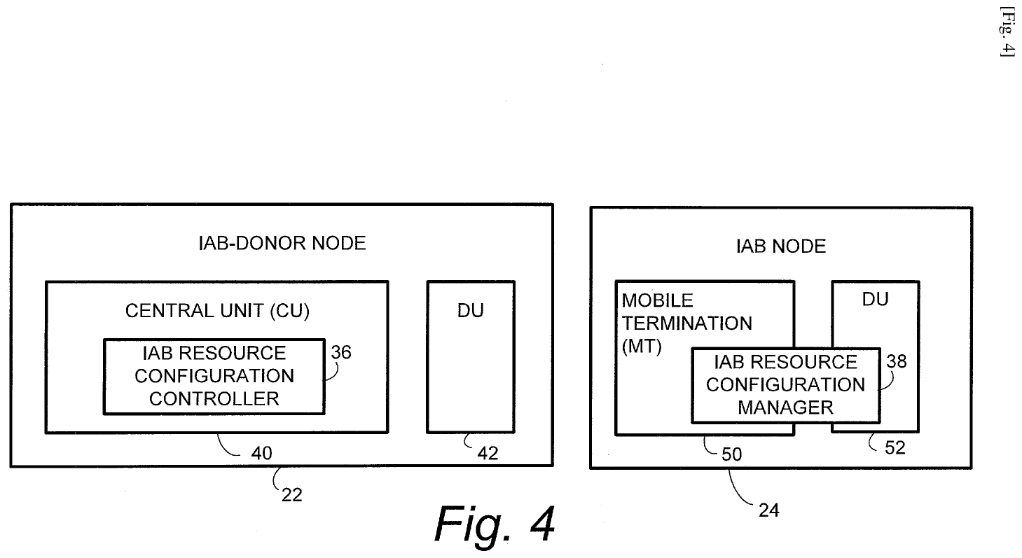

FIG. 4 depicts an example of functional block diagrams for the donor IAB node 22 and the IAB node 24 (see FIG. 3). The donor IAB node 22 may comprise at least one Central Unit (CU) 40 and at least one Distributed Unit (DU) 42. The Central Unit (CU) 40 is a logical entity managing the DU collocated in the donor IAB node 22 as well as the remote DUs resident in the IAB-nodes. The Central Unit (CU) 40 may also be an interface to the core network 21, behaving as a RAN base station (e.g., eNB or gNB).

In some embodiments, the Distributed Unit (DU) 42 is a logical entity hosting a radio interface (backhaul/access) for other child IAB-nodes and/or UEs. In one configuration, under the control of Central Unit (CU) 40 , the Distributed Unit (DU) 42 may offer a physical layer and Layer-2 (L2) protocols (e.g., Medium Access Control (MAC), Radio Link Control (RLC), etc.) while the Central Unit (CU) 40 may manage upper layer protocols (such as Packet Data Convergence Protocol (PDCP), Radio Resource Control (RRC), etc.). As shown in FIG. 4, the Central Unit (CU) 40 may host or comprise the IAB resource configuration controller 36, as hereinafter discussed.

As also shown in FIG. 4, an IAB node 24 may comprise Mobile-Termination (MT) 50 and Distributed Unit (DU) 52. In some example embodiments the Distributed Unit (DU) 52 may have the same functionality as the Distributed Unit (DU) 42 in the IAB-donor, whereas the Mobile-Termination (MT) 50 may be a UE-like function that terminates the radio interface layers. As an example, the Mobile-Termination (MT) 50 may function to perform at least one of: radio transmission and reception, encoding and decoding, error detection and correction, signaling, and access to a SIM. Either or both of the Mobile-Termination (MT) 50 and Distributed Unit (DU) 52 may comprise or host the IAB resource configuration manager 38.

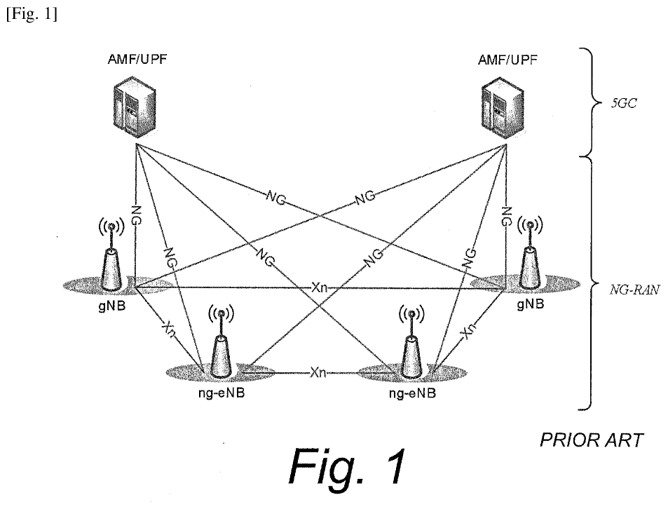

The DU may have all or parts of functions of an access node or gNB in FIG. 1 and an MT may have all or parts of functions of a UE. In other words, an access node or gNodeB may be rephrased by a CU and a DU, and the UE may be rephrased as a MT.

Embodiments include a mobile network infrastructure where a number of UEs are connected to a set of IAB-nodes and the IAB-nodes are in communication with each other for relay and/or an IAB-donor using the different aspects of the present embodiments. In some embodiments, the UE may communicate with the CU of the IAB-donor on the C-Plane using RRC protocol and in other embodiments, using Service Data Adaptation Protocol (SDAP) and/or Packet Data Convergence Protocol (PDCP) radio protocol architecture for data transport (U-Plane) through NR gNB. In some embodiments, the DU of the IAB-node may communicate with the CU of the IAB-donor using 5G radio network layer signaling protocol: F1 Application Protocol (F1-APS') which is a wireless backhaul protocol that provides signaling services between the DU of an IAB-node and the CU of an IAB-donor. That is, the protocol stack configuration may be interchangeable, and different mechanism may be used.

In some aspects and or example embodiments and modes a Mobile Termination (MT) functionality-typically provided by the User Equipment (UE) terminals-that may be implemented by Base Transceiver Stations (BTSs or BSs) nodes, for example, IAB nodes. In one embodiment, the MT functions may comprise common functions such as: radio transmission and reception, encoding and decoding, error detection and correction, signaling, and access to a SIM.

In a mobile network, an IAB child node may use the same initial access procedure (discovery) as an access UE to establish a connection with an IAB node/donor or parent-thereby attaching to the network or camping on a cell. In one embodiment, Radio Resource Control (RRC) protocol may be used for signaling between 5G radio network and UE, where RRC may have at least two states (e.g., RRC_IDLE and RRC_CONNECTED) and state transitions. The RRC sublayer may enable establishing of connections based on the broadcasted system information and may also include a security procedure. The U-Plane may comprise of PHY, MAC, RLC and PDCP layers.

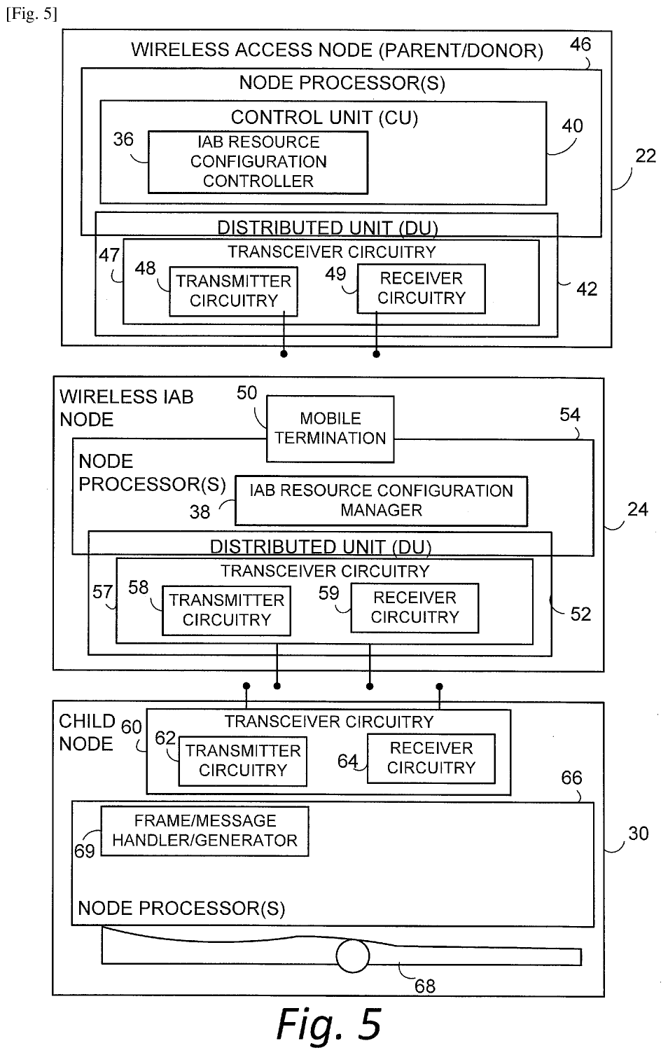

FIG. 5 shows in more detail a generic example embodiment and mode of arrangement and composition of certain functionalities and components of donor IAB node 22; an example, representative IAB node 24; and an example, representative user equipment (UE) 30. It should be understood that each of the nodes of FIG. 5 comprise additional components and functionalities known to the person skilled in the art, and that primarily those pertinent to the technology disclosed herein are illustrated for sake of simplicity.

As understood from the foregoing, FIG. 5 shows that donor IAB node 22 comprises central unit (CU) 40 and distributed unit (DU) 42. The central unit (CU) 40 and distributed unit (DU) 42 may be realized by, e.g., be comprised of or include, one or more processor circuits, e.g., donor node processor(s) 46. The one or more node processor(s) 46 may be shared by central unit (CU) 40 and distributed unit (DU) 42, or each of central unit (CU) 40 and distributed unit (DU) 42 may comprise one or more node processor(s) 46. Moreover, central unit (CU) 40 and distributed unit (DU) 42 may be co-located at a same node site, or alternatively one or more distributed units may be located at sites remote from central unit (CU) 40 and connected thereto by a packet network. The distributed unit (DU) 42 of donor IAB node 22 may comprise transceiver circuitry 47, which in turn may comprise transmitter circuitry 48 and receiver circuitry 49. The transceiver circuitry 47 includes antenna(e) for the wireless transmission. Transmitter circuitry 48 includes, e.g., amplifier(s), modulation circuitry and other conventional transmission equipment. Receiver circuitry 49 comprises, e.g., amplifiers, demodulation circuitry, and other conventional receiver equipment.

As shown in FIG. 5 the IAB-node 24, also known as wireless relay node 24, in an example embodiment and mode comprises the IAB node mobile termination (MT) unit 50 and IAB node distributed unit (DU) 52. The IAB node mobile termination (MT) unit 50 and IAB node distributed unit (DU) 52 may be realized by, e.g., by comprised of or include, one or more processor circuits, e.g., IAB node processor(s) 54. The one or more IAB node processor(s) 54 may be shared by IAB node mobile termination (MT) unit 50 and IAB node distributed unit (DU) 52, or each of IAB node mobile termination (MT) unit 50 and IAB node distributed unit (DU) 52 may comprise one or more IAB node processor(s) 54. The IAB node distributed unit (DU) 52 may comprise IAB node transceiver circuitry 57, which in turn may comprise IAB node transmitter circuitry 58 and IAB node receiver circuitry 59. The IAB node transceiver circuitry 57 includes antenna(e) for the wireless transmission. IAB node transmitter circuitry 58 may include, e.g., amplifier(s), modulation circuitry and other conventional transmission equipment. IAB node receiver circuitry 59 may comprise, e.g., amplifiers, demodulation circuitry, and other conventional receiver equipment.

FIG. 5 shows child node 30, shown by way of example as user equipment (UE) 30, as comprising, in an example, non-limiting embodiment and mode, transceiver circuitry 60. The transceiver circuitry 60 in turn may comprise transmitter circuitry 62 and receiver circuitry 64. The transceiver circuitry 60 includes antenna(e) for the wireless transmission. Transmitter circuitry 62 may include, e.g., amplifier(s), modulation circuitry and other conventional transmission equipment. Receiver circuitry 64 may comprise, e.g., amplifiers, demodulation circuitry, and other conventional receiver equipment. FIG. 5 further shows child node 30, which (as indicated before) may be a user equipment or Integrated Access and Backhaul (IAB) node, as also comprising node processor circuitry, e.g., one or more node processor(s) 66, and interfaces 68, including one or more user interfaces. Such user interfaces may serve for both user input and output operations, and may comprise (for example) a screen such as a touch screen that can both display information to the user and receive information entered by the user. The user interface 68 may also include other types of devices, such as a speaker, a microphone, or a haptic feedback device, for example.

In an example, non-limiting embodiment and mode shown in FIG. 5, the child node 30 may include frame/message generator/handler 69. As is understood by those skilled in the art, in some telecommunications system messages, signals, and/or data are communicated over a radio or air interface using one or more “resources”, e.g., “radio resource(s)”. The frame/message generator/handler 69 serves to handle messages, signals, and data received from other nodes.

Various aspects of IAB networks and nodes, and in some cases the virtualization of such networks and nodes, are described in one or more of the following United States Patent Applications, all of which are incorporated herein by reference:

U.S. Provisional Patent Application 62/780,068, filed Dec. 14, 2018, entitled “METHODS AND APPARATUS FOR CELL BARRING IN WIRELESS RELAY NETWORKS”.

U.S. Provisional Patent Application 62/753,699, filed Oct. 31, 2018, entitled “METHODS AND APPARATUS FOR USING CONDITIONAL HANDOVERS FOR WIRELESS”;

U.S. Provisional Patent Application 62/758,020, filed Nov. 8, 2018, entitled “NETWORK AND METHODS TO SUPPORT INTERDOMAIN MOBILITY IN VIRTUALIZED RADIO ACCESS NETWORK”;

U.S. Provisional Patent Application 62/748,359, filed Oct. 19, 2018, entitled “METHODS AND APPARATUS FOR CAPABILITY SIGNALING IN RADIO ACCESS NETWORK”;

U.S. Provisional Patent Application 62/748,015, filed Oct. 19, 2018, entitled “RADIO ACCESS NETWORK AND METHODS FOR EXPEDITED NETWORK ACCESS”.

U.S. Provisional Patent Application 62/790,922, filed Jan. 10, 2019, entitled “RESOURCE MANAGEMENT FOR WIRELESS BACKHAUL NETWORKS”.

U.S. Provisional Patent Application 62/790,922, filed Mar. 28, 2019, entitled “RESOURCE MANAGEMENT FOR WIRELESS BACKHAUL NETWORKS”.

B. General Description of Radio Resources and Iab Resource Configuration Signaling

Radio resources which may be used in the communication system 20 and in IAB networks generally are described in U.S. Provisional Patent Application 62/790,922, filed Mar. 28, 2019, entitled “RESOURCE MANAGEMENT FOR WIRELESS BACKHAUL NETWORKS”, which is incorporated herein by reference in its entirety.

In one of its example aspects the technology disclosed herein concerns resource indication signaling that allows for synchronization differences between a parent and child link for a given IAB node. In an IAB node, in general there will be timing differences between the links from the DU to its children and from its MT to its parents.

Various ways in which resource indication may occur are described herein based to some extent on 3GPP TR 38.874 V16.0.0 (2018-12), 3rd Generation Partnership Project; Technical Specification Group Radio Access Network; NR; Study on Integrated Access and Backhaul; (Release 16, incorporated herein by reference in its entirety, and recent agreements in IAB.

As used herein, a flexible resource is a resource in which the device to which the flexible resource is assigned makes no assumption about whether to transmit or receive on those resources, except via control signaling, and in particular L1 control signaling. Thus, the default characteristic of flexible resources as seen by client devices, e.g., UEs in RANs and MTs in IAB networks, is that they are “not available” for transmission by the client device, and a device to which these resources are assigned is not expected to be required to receive transmissions on those resources.

The following statement/definitions for resources, quoted from TR38.874, is/are applicable: “Each of the downlink, uplink and flexible time-resource types of the DU child link can belong to one of two categories:

Hard: The corresponding time resource is always available for the DU child link;

Soft: The availability of the corresponding time resource for the DU child link is explicitly and/or implicitly controlled by the parent node.”

For sake of clarification, flexible resources of the DU of the child can be “available” either “always” or “implicitly controlled by the parent node,” according to TR38.874. In legacy New Radio, NR, flexible resource assignment and utilization is done between a gNB and an access UE. For IAB, however, “flexible” resource assignment can be Hard/Soft allocated to a child's DU (if configured via RRC configuration, then, from the CU.)

Thus there are “hard” and “soft” flexible resources. Also, in terms of terminology used herein: IA=Indicated as available, NA =Not Available, F=Flexible, D=Downlink, U=Uplink, F=Flexible, H=Hard, S=Soft.

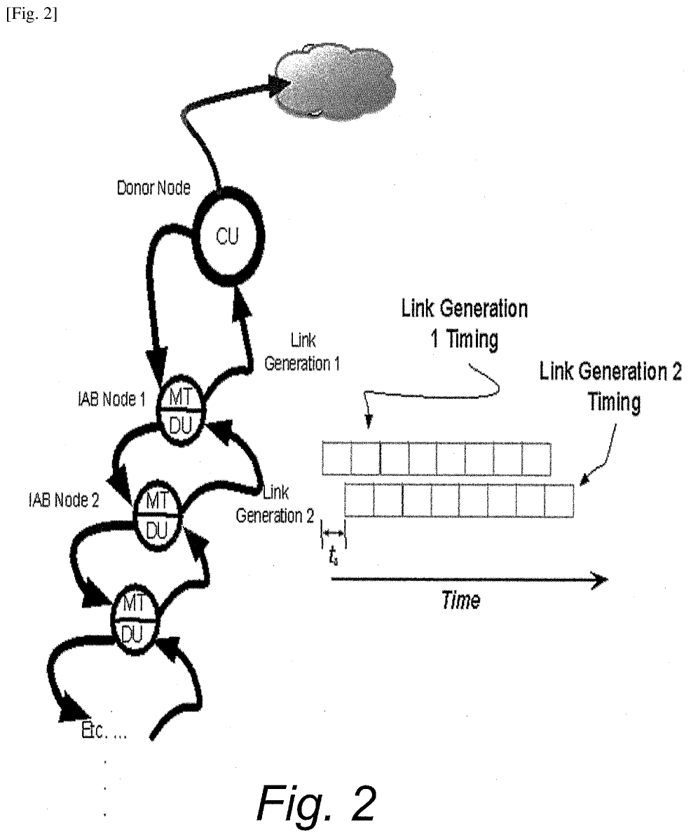

As previously indicated, FIG. 2 shows an example of a timing difference that may be unresolvable to zero between the MT timing and the DU timing in a single IAB node. Example aspects of the technology disclosed herein are methods of signaling and/or measurements that allow for indication of time delay and when a given resource can be made available.

Preparatory to further discussion, Table 1 shows information from the meeting report of RAN1#96bis meeting (R1-1905921 in https://www.3gpp.org/ftp/tsg_ran/WG1_RL1/TSGR1_97/Docs/) and Table 2 shows information from the agreements at the 3GPP RAN1#97 (Chairman's Notes RAN1#97 final.doc in https://www.3gpp.org/ftp/Meetings_3GPP_SYNC/RAN1/Inbox/Chairman_notes/).

```
TABLE 1
  In case of Hard or Soft Indicated Available DU resources, no additional
  exception cases need to be defined for cell specific signals/channels to
  be transmitted or received by the MT in the same resource (e.g.
  SS/PBCH blocks, SIreception, RACH).
      The decision on whether to give priority to the DU or to the MT
      for the use of the resource (e.g. in case of MT RACH transmission)
      is left to the IAB node implementation.
        The IAB shall fulfill its performance requirements in terms of
        measurement and transmission of cell specific signals/channels.
  In case of NA or Soft not Indicated Available DU resources, for
  potential conflicting configuration between NA and Soft not
  Indicated Available DU resources and cell-specific signals/channels
  (e.g. SSB, SI, PRACH) configured at the DU, the following alternatives
  are to be considered (to be down-selected):
      Alt 1): A resource with cell-specific signals/channels configured at
      DU shall not be configured as type NA or Soft without being
      Indicated Available.
      Alt 2): If a DU NA or Soft resource is configured with cell-specific
      signals/channels, the resource is treated as if it were a Hard DU
      resource.
  FFS the cell specific signals/channels. The list may include (not
  necessarily an exhaustive list)
      SSB transmissions
      Broadcast system information
      Configured periodic CSI-RS
      PRACH resources
      Resources for scheduling requests
  An IAB node has the ability to be made aware of the semi-static DU
  resource configuration (D/U/F/H/S/NA) of all its child IAB nodes.
    in the case the full DU resource configuration information of its child
    IAB nodes is not necessary, ensure that only the necessary
    configuration information is signaled to the IAB node.
        FFS the necessary configuration information.
An explicit indication of availability of a Soft resource by the parent node
makes the resource available to the child node, irrespective of the outcome
of any implicit determination of availability by the child node.
The parent node does not need to be aware of the outcome of an implicit
determination of availability of a DU Soft resources at a child node.
```

```
TABLE 2
For the semi-static DU resource configuration, the following is
supported:
  The resources are configured on a per DU (cell) basis
      FFS: indication of additional supplemental per-link resource
      configurations of child DUs
  Indication of D/U/F resources in the semi-static DU resource
  configuration includes the following:
      The flexibility to configure all of the slot patterns and formats
      supported by the existing Rel-15 TDD-UL-DL-Config RRC
      configurations and slot format table defined in Table 11.1.1-1 in
      TS38.213
          FFS: additional pattern durations than supported in Rel-15
          FFS: default resources or pattern
      New slot formats defined only for IAB nodes (DU and MTs) which
      begin with uplink slots, uplink symbols, or flexible symbols.
          Note: usage of these slot formats should be compatible with
          Rel-15 access UEs sharing the same link
          FFS: whether these slot formats also need to be included in
          the MT RRC configuration and/or SFI carried on DCI
          Format 2_0
  Indication of H/S/NA for the DU resource configuration is based on one
  of the following alternatives:
      Alt. 1: H/S/NA is additionally explicitly indicated per-resource
      type (D/U/F) in each slot
          To handle potential misalignment in time of the configured
          DU and MT resources when determining the validity of
          H/S/NA at the DU one of the following sub-alternatives need
          to be supported:
            1a: H/S/NA is applied relative to the DU resource
            configuration (D/U/F) slot timing without considering the
            MT resource configuration or timing.
              FFS: definition of additional restrictions on the usage
              of the semi-static configuration (e.g. guard symbols)
              based on deployment scenario or DL/UL switching
              times within an IAB node, etc.
              FFS: How the CU can get information about the
              required guard symbols for a given DU configuration
              if needed
            1b: H/S/NA is applied relative to the MT resource
            configuration (D/U/F) slot timing.
              FFS: Whether and/or how the CU will know the
              actual H/S/NA resources at the child DU
              FFS whether S is explicitly indicated or not
            1c: H is applied relative to the DU resource configuration
            (D/U/F) slot timing. S is not explicitly indicated, but
            implicitly determined by the DU based on whether the
            corresponding MT configuration indicates the MT
            resources is F (DU-S). The remaining resources are
            assumed to be NA at the child DU.
              FFS: Whether and/or how the CU will know the
              actual S/NA resources at the child DU
      Alt. 2: NA is explicitly indicated as a resource type in each slot for
      both the DU and MT configuration. H/S is not explicitly indicated,
      but implicitly determined by the DU based on the corresponding
      MT configuration
FFS: how to handle the case where there is not a 1-1 mapping of DUs and
MTs in the child IAB node
If a DU NA or Soft resource is configured with cell-specific
signals/channels, the resource is treated as if it were a Hard DU resource
(Alt. 2 from RAN1#96bis).
    The list of cell-specific signals/channels includes:
        resources for SSB transmission at DU, including both CD-SSB
        and non-CD-SSB;
        configured RACH occasions for receiving at the DU
        periodic CSI-RS transmission at the DU
        scheduled resource for receiving SR at DU
    The parent does not need to be aware of the cell-specific
    signals/channel configurations of the child DU
```

Table 4 and Table 5 below, taken from TR38.874 shown H/S/NA indications for the DU resource configurations alternatives, and are assumed to be generally true, except for differences that might arise due to synchronization mismatches between parent and child links. The definitions/nomenclature/assumption(s) of Table 5 are applicable for Table 3 and Table 4.

TABLE 3
DU and MT behaviour in case of TDM Operation

| DU | MT configuration | | |
|---|---|---|---|
| Configuration | DL | UL | F |
| DL-H | DU: Tx | DU: Tx | DU: Tx |
| | MT: NULL | MT: NULL | MT: NULL |
| DL-S | When DU | When DU | When DU |
| | resource: IA | resource: IA | resource: IA |
| | DU: Tx | DU: Tx | DU: Tx |
| | MT: NULL | MT: NULL | MT: NULL |
| | When DU | When DU | When DU |
| | resource: INA | resource: INA | resource: INA |
| | DU: NULL | DU: NULL | DU: NULL |
| | MT: Rx | MT: Tx | MT: Tx/Rx |
| UL-H | DU: Rx | DU: Rx | DU: Rx |
| | MT: NULL | MT: NULL | MT: NULL |
| UL-S | When DU | When DU | When DU |
| | resource: IA | resource: IA | resource: IA |
| | DU: Rx | DU: Rx | DU: Rx |
| | MT: NULL | MT: NULL | MT: NULL |
| | When DU | When DU | When DU |
| | resource: INA | resource: INA | resource: INA |
| | DU: NULL | DU: NULL | DU: NULL |
| | MT: Rx | MT: Tx | MT: Tx/Rx |
| F-H | DU: Tx/Rx | DU: Tx/Rx | DU: Tx/Rx |
| | MT: NULL | MT: NULL | MT: NULL |
| F-S | When DU | When DU | When DU |
| | resource: IA | resource: IA | resource: IA |
| | DU: Tx/Rx | DU: Tx/Rx | DU: Tx/Rx |
| | MT: NULL | MT: NULL | MT: NULL |
| | When DU | When DU | When DU |
| | resource: INA | resource: INA | resource: INA |
| | DU: NULL | DU: NULL | DU: NULL |
| | MT: Rx | MT: Tx | MT: Tx/Rx |
| NA | DU: NULL | DU: NULL | DU: NULL |
| | MT: Rx | MT: Tx | MT: Tx/Rx |

TABLE 4
DU and MT behaviour in case of SDM operation

| | DL | UL | F |
|---|---|---|---|
| DL-H | DU: Tx | DU: Tx | DU: Tx |
| | MT: NULL | MT: Tx | MT: Tx |
| DL-S | When DU | When DU | When DU |
| | resource: IA | resource: IA | resource: IA |
| | DU: Tx | DU: Tx | DU: Tx |
| | MT: NULL | MT: Tx | MT: Tx |
| | When DU | When DU | When DU |
| | resource: INA | resource: INA | resource: INA |
| | DU: NULL | DU: NULL | DU: NULL |
| | MT: Rx | MT: Tx | MT: Tx/Rx |
| UL-H | DU: Rx | DU: Rx | DU: Rx |
| | MT: Rx | MT: NULL | MT: Rx |
| UL-S | When DU | When DU | When DU |
| | resource: IA | resource: IA | resource: IA |
| | DU: Rx | DU: Rx | DU: Rx (only if |
| | MT: Rx | MT: NULL | MT is Rx and the |
| | When DU | When DU | DU knows that |
| | resource: INA | resource: INA | ahead of time) |
| | DU: NULL | DU: NULL | MT: Rx |
| | MT:Rx | MT: Tx | When DU |
| | | | resource: INA |
| | | | DU: NULL |
| | | | MT: Tx/Rx |
| F-H | DU: Tx/Rx | DU: Tx/Rx | DU: Tx/Rx |
| | MT: Rx (only if | MT: Tx (only if | MT: Tx (only if |
| | DU is Rx and the | DU is Tx and the | DU is Tx and the |
| | parent DU is | parent is aware in | parent DU knows |
| | aware in | advance) | that ahead of |
| | advance) | | time), Rx (only if |
| | | | DU is Rx and the |
| | | | parent DU is |
| | | | aware in |
| | | | advance) |
| F-S | When DU | When DU | When DU |
| | resource: IA | resource: IA | resource: IA |
| | DU: Tx/Rx | DU: Tx/Rx | DU: Tx/Rx |
| | MT: Rx (only if | MT: Tx (only if | MT: Tx (only if |
| | DU is Rx and the | DU is Tx and the | DU is Tx and the |
| | parent DU is | parent DU is | parent DU knows |
| | aware in | aware in | that ahead of |
| | advance) | advance) | time), Rx (only if |
| | When DU | When DU | DU is Rx and the |
| | resource: INA | resource: INA | parent DU is |
| | DU: NULL | DU: NULL | aware in |
| | MT: Rx | MT: Tx | advance) |
| | | | When DU |
| | | | resource: INA |
| | | | DU: NULL |
| | | | MT: Tx/Rx |
| NA | DU: NULL | DU: NULL | DU: NULL |
| | MT: Rx | MT: Tx | MT: Tx/Rx |

TABLE 5
DEFINITIONS/NOMENCLAURE/ASSUMPTIONS

“MT: Tx” means that the MT should transmit if scheduled
“DU: Tx” means that the DU may transmit
“MT: Rx” means that the MT should be able to receive (if there is
anything to receive)
“DU: Rx” means that the DU may schedule uplink transmissions from
child nodes or UEs
“MT: Tx/Rx” means that the MT should transmit if scheduled and should
be able to receive, but not simultaneously
“DU: Tx/Rx” means that the DU may transmit and may schedule uplink
transmission from child nodes and UEs, but not simultaneously
“IA” means that the DU resource is explicitly or implicitly indicated as
available
“INA” means that the DU resource is explicitly or implicitly indicated as
not available
“MT: NULL” means that the MT does not transmit and does not have to
be able to receive
“DU: NULL” means that the DU does not transmit and does not schedule
uplink transmission from child nodes and UEs
“NA” means the resources are “not available.”

C: RESOURCE MANAGEMENT CONSIDERING CHILD IAB SWITCHING TIME

In example embodiment and modes described herein resource management for an IAB network takes into consideration switching time of a child IAB node. That is, the time required for hardware of the child IAB node to switch between downlink reception and uplink transmission, or alternatively between uplink transmission and downlink reception, is factored into the resource management for the child IAB node, e.g., the time required for hardware of the child IAB node to change between uplink transmission and downlink reception. In one example embodiment and mode, the hardware involved in the switch includes hardware of the child IAB node, and particularly (1) the hardware involved as the child IAB node switches between uplink and downlink between the mobile termination unit and the distributed unit of the child IAB node. In another example embodiment and mode, the hardware involved in the switch comprises (2) hardware of the IAB node that is involved in a switch between uplink and downlink at the mobile termination unit of the child IAB node. In yet another example embodiment and mode, the hardware involved in the switch comprises (3) hardware of the child IAB node that is involved in a switch between uplink and downlink in the transceiver of the distributed unit of the child IAB node. In yet another example embodiment and mode, the hardware involved in the switch comprises (4) any combination of two or more of (1), (2), and (3). Thus, as used herein “switch time” may refer to any one or more of (1)-(4), and in at least some example embodiment and modes “switch time” may be conceptualized as comprising one or more factors or components, e.g., different components associated with the switching times (1)-(3). Such switch time is also referred to herein as “switching time characteristic” of the child IAB node. Such consideration of the switching time characteristic may be in addition to consideration of a timing gap between links in which the child IAB node participates, which was illustrated in FIG. 2.

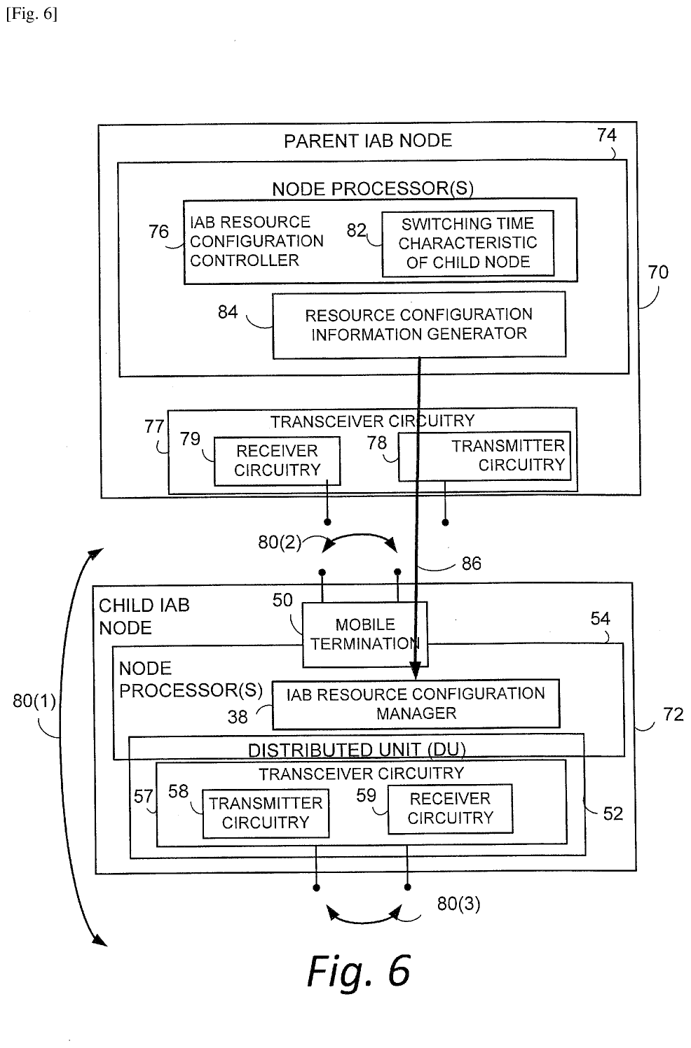

As a generic example FIG. 6 shows a representative parent IAB node 70 and a representative child IAB node 72. The parent IAB node 70 may be a donor IAB node such as donor IAB node 22 shown in FIG. 3 and FIG. 5, or a non-donor IAB node which also functions as a parent, such as IAB nodes 24 of FIG. 3 and FIG. 5.

The parent IAB node 70 comprises parent node processor circuitry 74, which in turn may include or function as IAB resource configuration controller 76. The parent IAB node 70 further comprises parent node transceiver circuitry 77, which further may include transmitter circuitry 78 and receiver circuitry 79. In a first case that the parent IAB node 70 is a donor IAB node 22, the parent node processor circuitry 74 may comprise or function as Central Unit (CU) 40, and the transceiver circuitry 47 may comprise or be realized by Distributed Unit (DU) 42, essentially in the manner shown in FIG. 5. In a second case that the parent IAB node 70 is not a donor IAB node 22 but another IAB node which serves as a parent IAB node to a child IAB node, the parent node processor circuitry 74 may be shown by IAB node processor(s) 54 of IAB node 24 of FIG. 5, and the transceiver circuitry 47 may comprise or be realized by IAB node transceiver circuitry 57 essentially in the manner shown in FIG. 5.

Concerning the two cases described above, typically the parent IAB node 70 is a donor IAB node such as donor IAB node 22 as described for the first case. But if the switching time capability of child node(s) is provided via F1-AP or over the air, e.g., MAC, L1 signaling, the parent IAB node 70 may be a non-donor node as described by the second case. In the second case situation in which the switching time capability of child node(s) is provided via F1-AP, such may be from a donor node, e.g., the switching time capability is indicated from each IAB node to a donor node so that the F1-AP provision may occur.

The child IAB node 72 of FIG. 6 may be essentially an IAB node 24 as shown in FIG. 5. As such, even with reference to FIG. 6, the child IAB node 72 may also be referred to as the IAB node 24. The child IAB node 72 like the IAB node 24 comprises Mobile-Termination (MT) 50 and Distributed Unit (DU) 52. One or more IAB node processor(s) 54 may serve to perform at least some functions of Mobile-Termination (MT) 50 and/or Distributed Unit (DU) 52. The IAB node processor(s) 54 may serve as the IAB resource configuration manager 38, as previously explained with reference to FIG. 5. Further, the Distributed Unit (DU) 52 may comprise IAB node transceiver circuitry 57, which in turn comprises IAB node transmitter circuitry 58 and IAB node receiver circuitry 59.

FIG. 6 further illustrates by one or more of arrows 80(1), 80(2), and 80(3) that the child IAB node 24 has a switching time characteristic. Arrow 80(1) depicts the time for the child node to switch between uplink and downlink between the mobile termination unit and the distributed unit of the child IAB node. Arrow 80(2) depicts the time for the child node to switch between uplink and downlink at the mobile termination unit of the child IAB node. Arrow 80(3) depicts the time for the child node to switch between uplink and downlink in the transceiver of the distributed unit of the child IAB node. As previously explained, one or more of (1)-(3) may comprise the switch time characteristic for the child IAB node 24. FIG. 6 further shows that the parent node processor circuitry 74 of parent IAB node 70 has knowledge of the switching time characteristic of the IAB node 72, e.g., that the switching time characteristic of the IAB node 24 is stored in a register or memory location 82 which is accessible by IAB resource configuration controller 76. FIG. 6 further shows that parent IAB node 70 comprises radio resource configuration information generator 84 which generates resource configuration information which takes into consideration the switching time characteristic of IAB node 72. The radio resource configuration information generator 84 may comprise the parent node processor circuitry 74 and may comprise IAB resource configuration controller 76 in particular. Arrow 86 further illustrates that the radio resource configuration information generated by radio resource configuration information generator 84 may be transmitted to the IAB node 72.

The radio resource configuration information generated by parent IAB node 70 inconsideration of the switching time characteristic of the child IAB node thus controls the manner in which the parent IAB node 70 itself may communication with the child IAB node 72. In other words, the transmitter circuitry 78 and receiver circuitry 79 are configured to perform wireless communications in consideration of the switching time characteristic of the child IAB node.

The child IAB node 72/IAB node 24 of FIG. 6 includes the IAB node processor(s) 54 and Mobile-Termination (MT) 50. In the example embodiment and mode of FIG. 6, the Mobile-Termination (MT) 50 includes receiver circuitry that receives the radio resource configuration information from the parent node, e.g., the parent IAB node 70. The radio resource configuration information may be received in a message such as radio resource configuration information message 86. The radio resource configuration information received by the child IAB node 72 is configured to take into consideration a switching time characteristic of the child IAB node. Upon reception of the radio resource configuration information, the processor circuitry 54 is configured to control wireless communications of the child IAB node in accordance with the radio resource configuration information.

The switching time characteristic of the child IAB node comprises an indication of an amount of time required for hardware of the child IAB node to change between uplink transmission and downlink reception. In being an “indication, the switching time characteristic may or may not be a quantitative value. An example of a quantitative value may be for example, an expression such as a number of slots or Orthogonal Frequency Division Multiplexing (OFDM) symbols. When not a quantitative value, the switching time characteristic may be a predefined code or reference value know both to parent IAB node 70 and child IAB node 72. For example, the indication of switching time characteristic may be expressed as a category of switching time characteristic values.

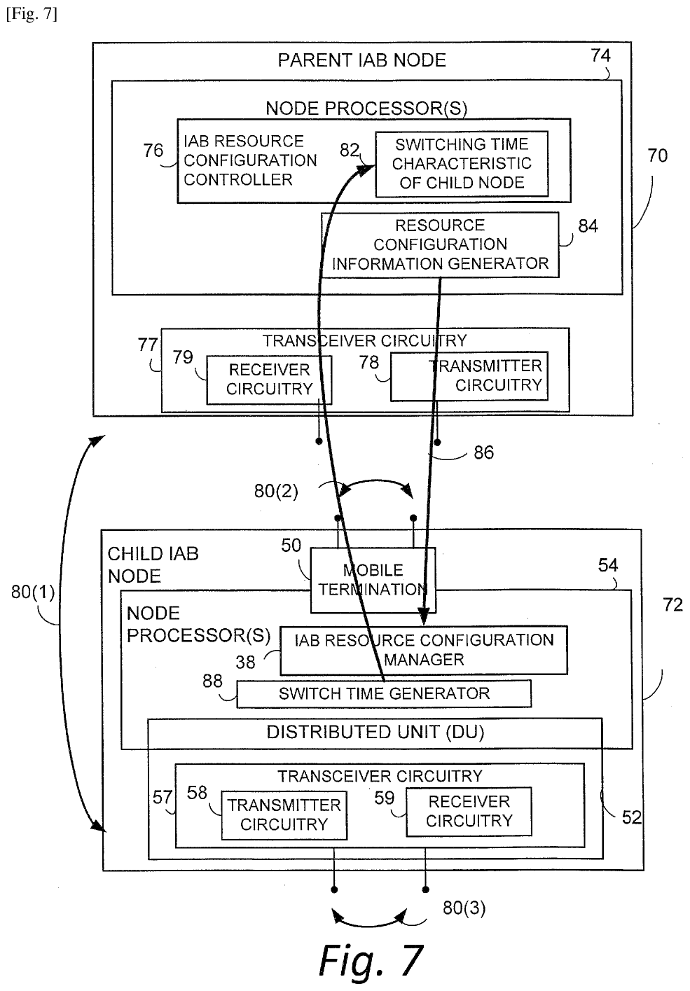

The switching time characteristic of the child IAB node 72 may be configured at the parent IAB node 70, e.g., in memory 82 for switching time characteristic of child IAB node. Alternatively, as indicated by the example embodiment and mode shown in FIG. 7, the switching time characteristic may be communicated to the parent IAB node 70 in a message generated by child IAB node 72.

In another example embodiment and mode shown in FIG. 7, the child IAB node 72/IAB node 24 is configured to transmit switching time characteristic information of the child IAB node in a message to the parent IAB node. FIG. 7 particularly shows that the IAB node processor(s) 54 of parent IAB node 70 comprises switching time characteristic information generator 88, which generates switching time characteristic information that is included in a message 89. The message 89 that includes the switching time characteristic information is transmitted by a transmitter circuitry of Mobile-Termination (MT) 50 to parent IAB node 70, where it is received and may be stored in the memory 82 for switching time characteristic of child IAB node. In an example implementation, the message 89 that includes the switching time characteristic information of the child IAB node may be an IAB node capability message.

The switching time characteristic information generator 88 may generate the switching time characteristic information that is included in a message 89 in any suitable format or manner. Moreover, as described above, the switching time characteristic may have one or more factors or components, e.g., different components associated with the switching time (1) involved as the child IAB node switches between uplink and downlink between the mobile termination unit and the distributed unit of the child IAB node; (2) involved in a switch between uplink and downlink at the mobile termination unit of the child IAB node; and (3) involved in a switch between uplink and downlink in the transceiver of the distributed unit of the child IAB node. In an example embodiment and mode in which these components may be differentiated, the components may be transmitted separately, e.g., in separate information elements.

The child IAB node 72/IAB node 24 may include a memory comparable to memory or register 82 of the parent IAB node for storing the switching time characteristic of child IAB node and/or the components thereof. The switching time characteristic of child IAB node may be determined by diagnostic measurement of the switching time(s) and/or one or more of any components thereof, during operation of the child IAB node or other child IAB nodes comparably constructed and/or situated, or in any other suitable manner. After such measurement or determination, the switching time characteristic of child IAB node may be configured/stored in the register or memory unit either locally, e.g., preconfigured, or downloaded through the network.

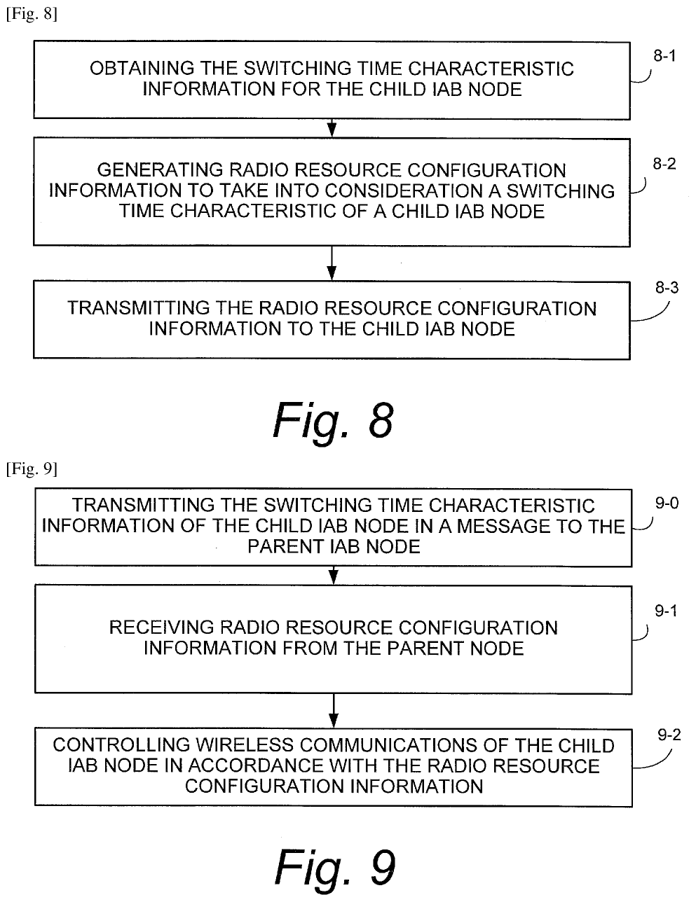

FIG. 8 illustrates example, representative basic acts or steps that may be performed by the parent IAB node 70 of FIG. 6 and FIG. 7. Act 8-1 comprises obtaining the switching time characteristic information for the child IAB node 72/IAB node 24. For the example embodiment and mode of FIG. 6, act 8-1 may comprise obtaining the switching time characteristic of the child IAB node from the memory 82. For the example embodiment and mode of FIG. 7 act 8-1 may comprise receiving a message 89 from child IAB node 72 that includes an indication of the switching time characteristic of the child IAB node. Act 8-2 comprises generating radio resource configuration information to take into consideration a switching time characteristic of a child IAB node. Act 8-3 comprises transmitting the radio resource configuration information to the child IAB node.

FIG. 8 illustrates example, representative basic acts or steps that may be performed by the parent IAB node 70 of FIG. 6 and FIG. 7. Act 8-1 comprises obtaining the switching time characteristic information for the child IAB node 72/IAB node 24. For the example embodiment and mode of FIG. 6, act 8-1 may comprise obtaining the switching time characteristic of the child IAB node from the memory 82. For the example embodiment and mode of FIG. 7 act 8-1 may comprise receiving a message 89 from child IAB node 72 that includes an indication of the switching time characteristic of the child IAB node. Act 8-2 comprises generating radio resource configuration information to take into consideration a switching time characteristic of a child IAB node. Act 8-3 comprises transmitting the radio resource configuration information to the child IAB node.

FIG. 9 illustrates example, representative basic acts or steps that may be performed by the child IAB node 72 of FIG. 6 and FIG. 7. Act 9-0 is performed only by the child IAB node 72 of FIG. 7, while the remaining acts of FIG. 9 may be performed by the child IAB nodes 72 of FIG. 6 and FIG. 7. Act 9-0 comprises transmitting the switching time characteristic information of the child IAB node in a message to the parent IAB node. Act 9-1 comprises receiving radio resource configuration information from the parent node. The radio resource configuration information of act 9-1 is configured to take into consideration a switching time characteristic of the child IAB node. Act 9-2 comprises controlling wireless communications of the child IAB node in accordance with the radio resource configuration information.

The example embodiment and modes of FIG. 6 and FIG. 7 are particularly but not necessarily exclusively applicable to a situation in which H/S/NA is additionally explicitly indicated per-resource type (D/U/F) in each slot, and H/S/NA is applied relative to the DU resource configuration (D/U/F) slot timing without considering the MT resource configuration or timing. In other words, IAB resource configuration controller 76 of parent IAB node 70 is configured to explicitly indicate a character per resource type in each slot of the radio resource configuration indicated by the radio resource configuration information. The character is one of hard, soft, or not available, and the resource type being one of downlink, uplink, and flexible. In the example embodiments and modes of FIG. 6 and FIG. 7, IAB resource configuration controller 76 of parent IAB node 70 is configured not to consider configuration or timing of a mobile termination unit of the child IAB node.

The example embodiments and modes of FIG. 6 and FIG. 7 thus may communicate IAB node capability as part of IAB capability information exchange in a manner to provide information about the required guard symbols for a given DU configuration if needed.

As mentioned above, the IAB resource configuration controller 76 may also be configured to generate the radio resource configuration information to take into consideration a timing gap between a first link and a second link. In this sense, the first link may be between the parent IAB node a mobile termination unit of the child node, and the second link may be between a distributed unit of the child IAB node and a further IAB node which is a child of the child IAB node.

C: Resource Management with First Resource Constraint for Child Iab Node

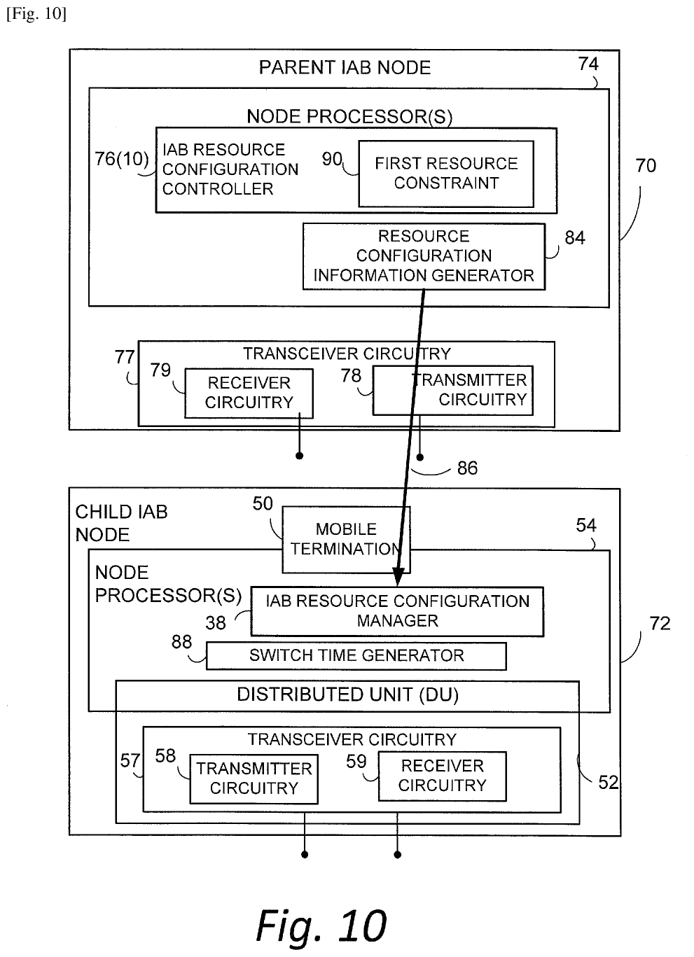

FIG. 10 shows portions of another example embodiment and mode of an Integrated Access and Backhaul (IAB) network which also includes parent IAB node 70 and child IAB node 72. Nodes, components, and functionalities of the example embodiment and mode of FIG. 10 which have same or similar reference numerals with those of FIG. 5, FIG. 6, and FIG. 7 are understood to be the same or similar in structure and operation unless otherwise described herein.

Although not shown as such in FIG. 10, the parent IAB node 70 of FIG. 10 may also take into consideration the switching time characteristic of the child IAB node in like manner as the example embodiments and modes of FIG. 6 or FIG. 7. That is, the parent IAB node 70 may also include memory 82 for switching time characteristic of child IAB node and IAB resource configuration controller 76 that takes the switching time characteristic of the child IAB node in consideration in generating the radio resource configuration information message 86.

Alternatively or additionally to taking into consideration the switching time characteristic of the child IAB node, the IAB resource configuration controller 76(10) of the parent IAB node 70 of FIG. 10 may be configured to control a first resource (OFDM symbol in a slot) to be a soft DU resource, and to never hand such soft resource over to the child IAB node 72. In this context, “first resource” may be or include a first OFDM symbol in each slot. Thus, FIG. 10 shows IAB resource configuration controller 76(10) as operating in conjunction with a first resource constraint 90. The first resource constraint requires that the IAB resource configuration controller 76(10) first resource be a soft DU resource, such soft resource is never handed over or allocated to the child IAB node 72.

The example embodiment and mode of FIG. 10 is particularly but not exclusively applicable to a situation in which H/S/NA is additionally explicitly indicated per-resource type (D/U/F) in each slot, and H/S/NA is applied relative to the MT resource configuration (D/U/F) slot timing. Thus, in the situation for the example embodiments and modes of FIG. 6 and FIG. 7 the configuration of H/S/NA flavors is applied the DU configuration, while in the situation of the example embodiment and mode of FIG. 10 the configuration of the H/S/NA flavors is applied to the MT configuration.

The soft resources of the child link are explicitly and/or implicitly controlled by the parent, and the DU state can be inferred from the MT state, as per the aforementioned tables. Thus, the example embodiment and mode of FIG. 10 may include methods such as:
Communication of switching time capability at connection, as in the example embodiments and modes of FIG. 6 and FIG. 7, since the timing difference issue will still happen even if it's the MT resources that are configured
Signaling from a child to parent to indicate its DU/MT “timing gap”, as also mentioned in the example embodiments and modes of FIG. 6 and FIG. 7, since the timing difference issue will still happen even if it's the MT resources that are configured.
Signaling from Child to CU indicating resources delegated to child DU.

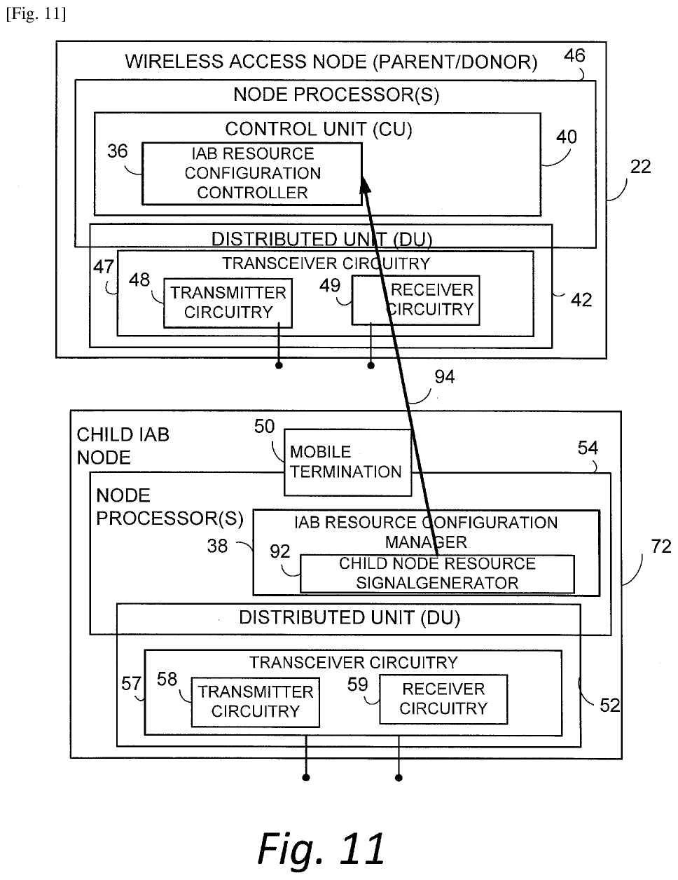

The third bullet point above is illustrated, by way of example, in FIG. 11, in which IAB node processor(s) 54, e.g., IAB resource configuration manager 38, comprises a child node resource delegation signal generator 92. The child node resource delegation signal generator 92 generates a signal 94 to the Central Unit (CU) 40 of the donor IAB node 22 which indicates the resources delegated to the distributed unit 52 of the child IAB node 72/IAB node 24. Nodes, components, and functionalities of the example embodiment and mode of FIG. 11 which have same or similar reference numerals with those of FIG. 5, FIG. 6, FIG. 7, and FIG. 10 are understood to be the same or similar in structure and operation unless otherwise described herein.

S (soft resources) indicated for the child node or not may be expressed in manners already consistent with the slot format indication signalling that have been previously disclosed. Thus the above bullet points address issues including but not limited to the timing difference management between links.

D: Resource Management with Coincidence Prohibition Constraint for Child Iab Node

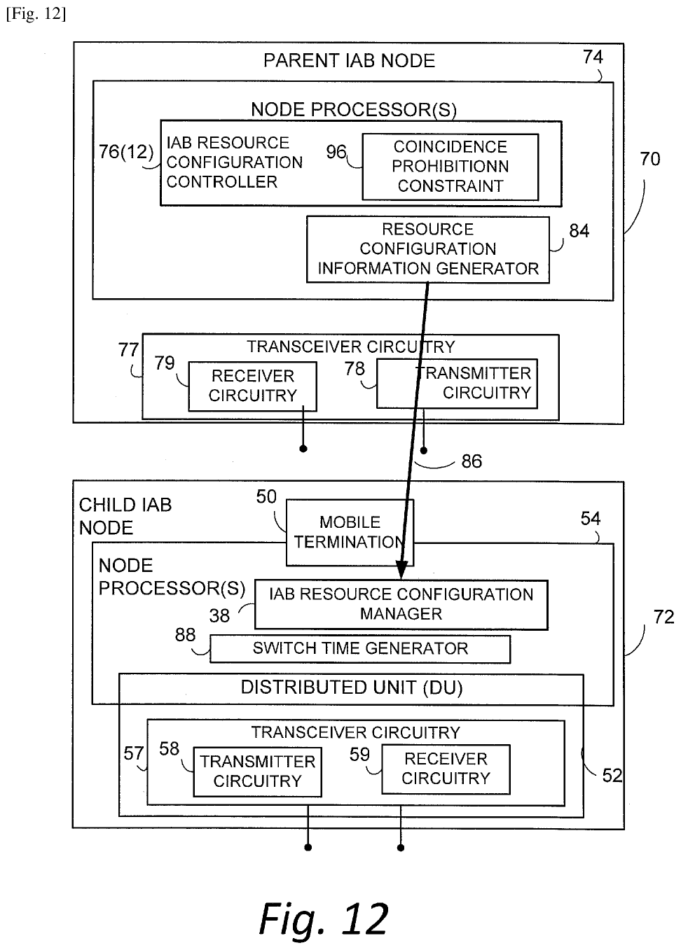

FIG. 12 shows portions of another example embodiment and mode of an Integrated Access and Backhaul (IAB) network which also includes parent IAB node 70 and child IAB node 72. Nodes, components, and functionalities of the example embodiment and mode of FIG. 12 which have same or similar reference numerals with those of FIG. 5, FIG. 6, FIG. 7, FIG. 10, and FIG. 11 are understood to be the same or similar in structure and operation unless otherwise described herein.

Although not shown as such in FIG. 12, the parent IAB node 70 of FIG. 12 may also take into consideration, e.g., (1) the switching time characteristic of the child IAB node in like manner as the example embodiments and modes of FIG. 6 or FIGS. 7; and (2) the signaling from the child IAB node to the Central Unit (CU) 40 of the donor IAB node 22, the resources delegated to the Distributed Unit (DU) 52 of the IAB node 24/child IAB node 72.

Alternatively or additionally, the IAB resource configuration controller 76(12) of the parent IAB node 70 of FIG. 12 may be configured never to schedule transmission coinciding with a transmission of the Distributed Unit (DU) 52 of the child IAB node 72. In other words, the parent DU, e.g., the DU of parent IAB node 70, is controlled never to schedule transmission coinciding with a transmission of the Distributed Unit (DU) 52 of the child IAB node 72. Thus, FIG. 12 shows IAB resource configuration controller 76(12) as operating in conjunction with a coincidence prohibition constraint 96.

The example embodiment and mode of FIG. 12 is particularly but not exclusively applicable to a situation in which H/S/NA is additionally explicitly indicated per-resource type (D/U/F) in each slot; H is applied relative to the DU resource configuration (D/U/F) slot timing; S is not explicitly indicated, but implicitly determined by the DU based on whether the corresponding MT configuration indicates the MT resources is F (DU-S); and the remaining resources are assumed to be NA at the child DU.

The example embodiment and mode of FIG. 12 makes an explicit relationship between flexible resources “at” the MT, which are used by the parent IAB node 70 for transmitting and receiving from the Child MT, and soft resources “at” the DU. The example embodiment and mode of FIG. 12 precludes a soft resource assigned to the DU that is always NA for the MT.

This coincidence prohibition constraint 96 may will limit flexibility of resource utilization. Accordingly, as a variation, implementation of the coincidence prohibition constraint 96 may be selective, e.g., the coincidence prohibition constraint 96 may be configurable.

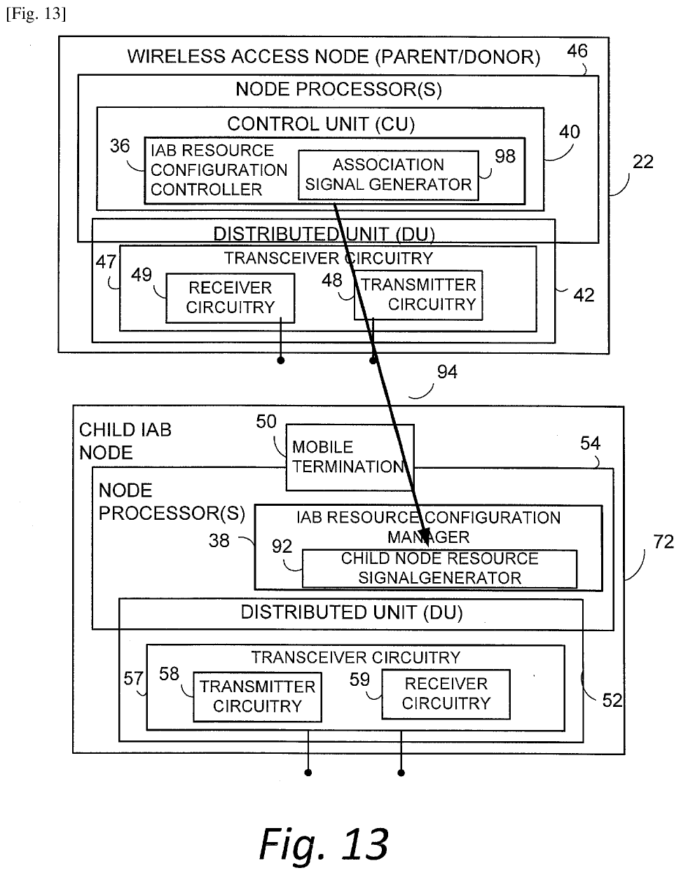

In addition, the example embodiment and mode of FIG. 12 may also involve:
Signaling from Child to CU indicating resources delegated to child DU (in a manner such as that shown in FIG. 11)
Signaling from CU to child IAB node to (re)configure association between DU-S and MT-F (in a manner described with reference to FIG. 13).

In FIG. 13, the Central Unit (CU) 40 of donor IAB node 22 includes association signal generator 98 which generates a signal that (re)configures association between DU-S and MT-F. The association signal generated by association signal generator 98 is transmitted by Distributed Unit (DU) 42 of donor IAB node 22 to the child IAB node 72/IAB node 24 for use by IAB resource configuration manager 38. Nodes, components, and functionalities of the example embodiment and mode of FIG. 13 which have same or similar reference numerals with those of FIG. 5, FIG. 6, FIG. 7, FIG. 10, FIG. 11, and FIG. 12 are understood to be the same or similar in structure and operation unless otherwise described herein.

E: Resource Management when DU/MT Mapping is Not 1:1

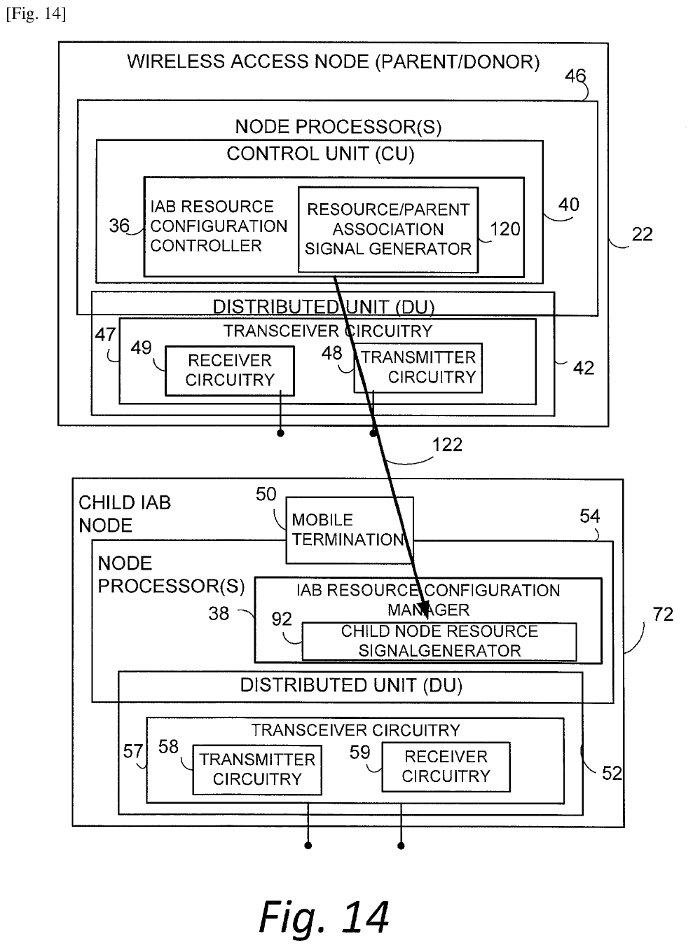

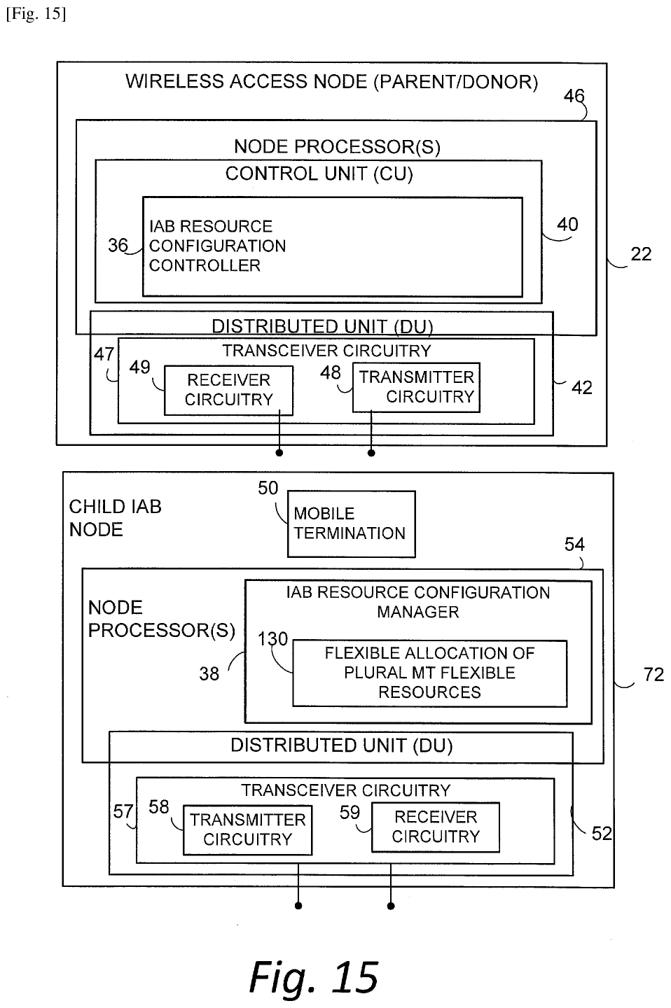

FIG. 14 and FIG. 15 show portions of other example embodiments and modes of an Integrated Access and Backhaul (IAB) network which also includes parent IAB node 70 and child IAB node 72. Nodes, components, and functionalities of the example embodiment and mode of FIG. 14 and FIG. 15 which have same or similar reference numerals with those of FIG. 5, FIG. 6, FIG. 7, FIG. 10, FIG. 11, FIG. 12, and FIG. 13 are understood to be the same or similar in structure and operation unless otherwise described herein.

The example embodiments and modes of FIG. 14 and FIG. 15 are particularly but not exclusively applicable to a situation in which NA is explicitly indicated as a resource type in each slot for both the DU and MT configuration, and H/S is not explicitly indicated, but implicitly determined by the DU based on the corresponding MT configuration.

Although not shown as such in FIG. 14 and FIG. 15, the parent IAB node 70 may also take into consideration, e.g., the same kind of (re)configurable constrains as we have for the example embodiment and mode of FIG. 12 and FIG. 13, and thus may include from Central Unit (CU) 40 of donor IAB node 22 to the child IAB node 72/IAB node 24 to (re)configure association between DU-S and MT-F. While not necessarily saving a large number of bits, this capability may help in signalling the slot formats.

Additionally or alternatively, the example embodiment and mode of FIG. 14 and FIG. 15 may be beneficial in a first case in which there is not a 1-1 mapping of DUs and MTs in the child IAB node, and in a second case which appears in the example embodiment and mode of FIG. 12 and FIG. 13. Such cases may arise in the event that a child has multiple parents. In either first case or the second case, the Central Unit (CU) 40 needs to have and transmit indicative RRC signalling to the parents of an IAB node MTs and DUs, as to which resources are under the control of which parents. To this end, FIG. 14 shows the Central Unit (CU) 40 of donor IAB node 22 as comprising resource/parent association signal generator 120. The resource/parent association signal generator 120 generates a signal 122 which specifies which resources are under the control of which parents. The signal 122 which includes resource/parent association information is transmitted by Distributed Unit (DU) 42 to the Mobile-Termination (MT) 50 of the child IAB nodes 72.

FIG. 15 shows a variation in which the child IAB node 72 uses the H/S allocation DU configuration based on the plurality of MT configurations. That is, the IAB node can consider the H/S allocation based on flexible allocations of the plurality of MTs' flexible resources. FIG. 15 specifically shows that IAB resource configuration manager 38 of IAB node 24 has access to memory 130 or storage of flexible allocations of plurality of MT's flexible resources.

The foregoing has described, e.g., several types of signaling, including the following non-limiting examples:
In communicating JAB node capability switching time category can be included as part of JAB node capability.
   This switching time capability may be expressed as a plurality of slots or OFDM symbols.
Signaling from Child to CU indicating resources delegated to child DU.
   Signaling may include slot format and/or DU resource configuration, i.e., H, S, or N/A
Signaling from CU to child JAB node to (re)configure association between DU-S and MT-F.
MTs and DUs, in the event of a lack of correspondence between MTs and DUs, (say more MT's than DUs) there needs to be communication between parents facilitated by the CU to inform the parents as to which resources are used by which MTs. Alternatively, the IAB node uses the H/S allocation DU configuration based on the plurality of MT configurations.

Two forms of signaling are being considered for managing configuration of objects IAB networks, namely RRC configuration and F1-AP signaling. RRC signaling can be used to indicate to the CU, resources assigned to a child from a parent as per the slot format indication signaling which has been described in U.S. Provisional Patent Application 62/790,922, filed Mar. 28, 2019, entitled “RESOURCE MANAGEMENT FOR WIRELESS BACKHAUL NETWORKS”. In addition, transition time can be either assumed to be as in Table 3 of U.S. Provisional Patent Application 62/790,922 or configurable in units of OFDM symbols or slots. $ As for F1 signaling, the interface and context management procedures described in TS38.473 may be modified, see, e.g., 3rd Generation Partnership Project; Technical Specification TS38.473 Group Radio Access Network; NG-RAN; F1 application protocol (FLAP) (Release 15), which is incorporated herein by reference in its entirety. RRC messages may also be carried on the F 1-C interface as well TS38.473, section 8.4, or TS38.470 section 5.24. See, e.g., 3rd Generation Partnership Project; Technical Specification TS38.470 Group Radio Access Network; NG-RAN; F1 general aspects and principles (Release 15) which is incorporated herein by reference in its entirety. In the case of RRC messages carried over the F1-C interface the signaling from the child DU to the CU indicating resources delegated to the child DU would be achieved using the UPLINK RRC TRANSFER message to the gNB-CU including the RRC message as a RRC-Container IE.

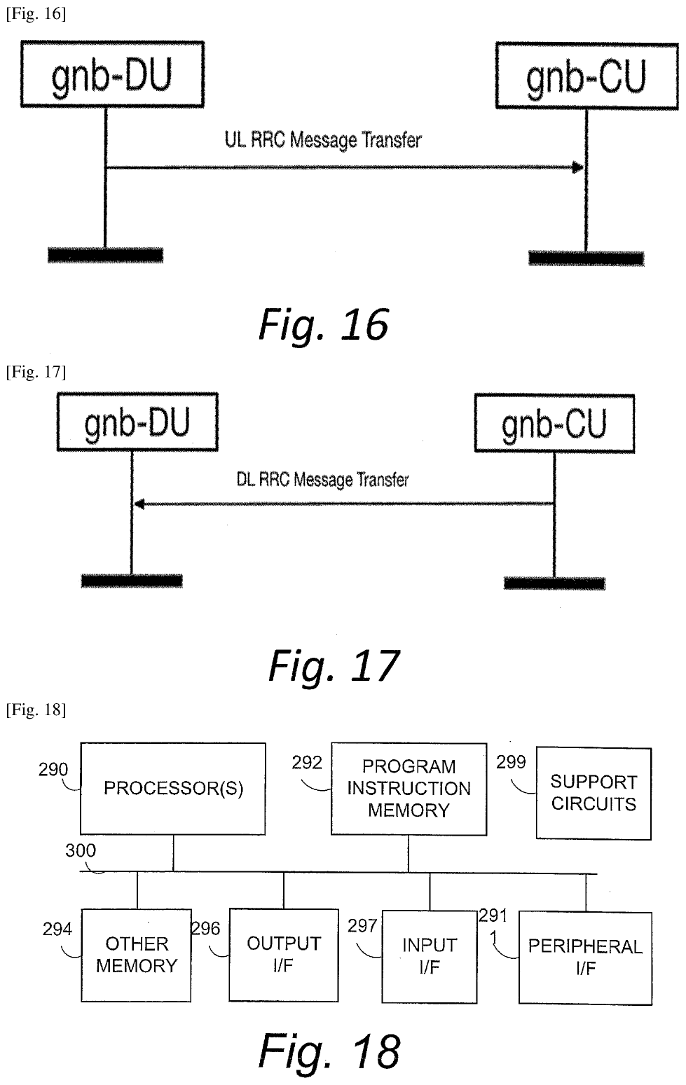

FIG. 16 shows an UL RRC message which may be carried in an RRC-Container IE encapsulated in an F1 message uplink that may be used for indicating Child DU allocated resources.

FIG. 17 represents downlink signaling which may be used in the case of (re)configuration of resources for (re)association of resources between DU-S and MTF resources.

Conversely, F1 messages may be encapsulated in a container in RRC messaging; however this approach would entail greater specification effort as the container for RRC signaling already exists; it is the RRC information that needs to be added.

It should be understood that, unless otherwise indicate or apparent from context, one or more of the features of the example embodiments and modes herein, such as for example FIG. 6, FIG. 7, FIG. 10-FIG. 15, may be utilized in conjunction with features from other one or more of such example embodiments and modes.

Certain units and functionalities of the systems 20 may be implemented by electronic machinery. For example, electronic machinery may refer to the processor circuitry described herein, such as IAB node processor(s) 54, donor node processor(s) 46, and node processor(s) 66. Moreover, the term “processor circuitry” is not limited to mean one processor, but may include plural processors, with the plural processors operating at one or more sites. Moreover, as used herein the term “server” is not confined to one server unit, but may encompasses plural servers and/or other electronic equipment, and may be co-located at one site or distributed to different sites. With these understandings, FIG. 18 shows an example of electronic machinery, e.g., processor circuitry, as comprising one or more processors 290, program instruction memory 292; other memory 294 (e.g., RAM, cache, etc.); input/output interfaces 296 and 297, peripheral interfaces 298; support circuits 299; and busses 300 for communication between the aforementioned units. The processor(s) 290 may comprise the processor circuitries described herein, for example, IAB node processor(s) 54, donor node processor(s) 46, and node processor(s) 66.

An memory or register described herein may be depicted by memory 294, or any computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory. The support circuits 299 are coupled to the processors 290 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the wireless access node 22, the wireless relay node 24, and/or the wireless terminal/wireless node 30 used in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semi-conductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves basic function of a radio access network, e.g., methods and procedures to deal with resource allocation and utilization in an IAB network in view of problematic issues such as time delays, for example.

One or more of the following documents, all of which are incorporated herein in their entirety, may be pertinent to the technology disclosed herein:
R1-1907679, 3GPP TSG RAN WG1 Meeting #97, Reno, USA, 13th-17th May, 2019, “Summary of 7.2.3.3 Mechanisms for resource multiplexing among backhaul and access links”, AT&T.
R1-1906456, 3GPP TSG RAN WG1 Meeting #97, Reno, USA, May 13^{th}-17^{th}, 2019, “Discussion on OTA timing mechanism”, ZTE, Sanechips.
R1-1907117 3GPP TSG RAN WG1#97, Reno, USA, 13^{th}-17^{th} May, 2019, “Open items with IAB Case #1 timing”, Nokia, Nokia Shanghai Bell.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

<Summary>

In one example, a parent Integrated Access and Backhaul (IAB) node that communicates over a radio interface, the parent IAB node comprising: processor circuitry configured to generate radio resource configuration information to take into consideration a switching time characteristic of a child IAB node; transmitter circuitry configured to transmit the radio resource configuration information to the child IAB node.

In one example, the parent IAB node, further comprising receiver circuitry, and wherein the transmitter circuitry and receiver circuitry are configured to perform wireless communications in consideration of the switching time characteristic of the child IAB node.

In one example, the parent IAB node, wherein the processor circuitry is configured to explicitly indicate a character per resource type in each slot of the radio resource configuration indicated by the radio resource configuration information, the character being one of hard, soft, or not available, and the resource type being one of downlink, uplink, and flexible; and wherein the processor circuitry is configured not to consider configuration or timing of a mobile termination unit of the child IAB node.

In one example, the parent IAB node, wherein the switching time characteristic of the child IAB node comprises an indication of an amount of time required for hardware of the child IAB node to change between uplink transmission and downlink reception.

In one example, the parent IAB node, wherein the indication of the amount of time required for the hardware of the child IAB node to change between the uplink transmission and the downlink reception is expressed as a number of slots or Orthogonal Frequency Division Multiplexing (OFDM) symbols.

In one example, the parent IAB node, further comprising receiver circuitry configured to receive switching time characteristic information of the child IAB node in a message from the child IAB node; and wherein the processor circuitry is configured to generate the radio resource configuration information using the switching time characteristic information.

In one example, the parent IAB node, wherein the receiver circuitry is configured to receive the switching time characteristic information in an IAB node capability message from the child IAB node.

In one example, the parent IAB node, wherein in generating the radio resource configuration the processor circuitry is configured to assign a first resource as a soft distributed unit resource to the child IAB node, and to not allow the child IAB node to communicate in the first resource.

In one example, the parent IAB node, wherein: the processor circuitry is configured to not schedule a transmission to the child IAB node if the transmission were to coincide with a transmission from the child IAB node.

In one example, the parent IAB node, wherein the processor circuitry is configured to generate the radio resource configuration information to take into consideration a timing gap between a first link and a second link, the first link being between the parent IAB node a mobile termination unit of the child node, the second link being between a distributed unit of the child IAB node and a further IAB node which is a child of the child IAB node.

In one example, the parent IAB node, wherein the processor circuitry is configured to explicitly indicate a character per resource type in each slot of the radio resource configuration, the character being one of hard, soft, or not available, and the resource type being one of downlink, uplink, and flexible; and wherein the processor circuitry is configured to allocate the character of the resource type in each slot relative to configuration slot timing of a mobile termination unit of the child IAB node.

In one example, the parent IAB node, wherein the parent IAB node is a Donor IAB node, and wherein the receiver circuitry is configured to receive a signal indicating resources delegated to the child IAB node.

In one example, the parent IAB node, wherein the processor circuitry is configured to generate a signal to the child IAB node to reconfigure an association between a soft resource allocated to the distributed unit of the child IAB node and a flexible resource allocated to the mobile termination unit of the child IAB node.

In one example, the parent IAB node, wherein the processor circuitry is configured to preclude assignment of a resource as a soft resource to a distributed unit of the child IAB node when the resource is always not available for a mobile termination unit of the 0020 child IAB node.

In one example, the parent IAB node, wherein: the processor circuitry is configured to selectively preclude assignment of the resource as a soft resource to the distributed unit of the child IAB node when the resource is always not available for the mobile termination unit of the child IAB node.

In one example, the parent IAB node, wherein the processor circuitry is configured to indicate a character per resource type in each slot of the radio resource configuration, the character being one of hard, soft, or not available, and the resource type being one of downlink, uplink, and flexible; and wherein the processor circuitry is configured to apply a hard character relative to a DU resource configuration but implicitly indicate a soft character to be determined by the distributed unit of the child IAB node based on whether a corresponding MT configuration indicates the MT resource is F (DU-S).

In one example, the parent IAB node, wherein: the processor circuitry is configured to signal to the child IAB node an association between soft resources of a distributed unit of the child IAB node and flexible resource of a mobile termination unit of the child IAB node.

In one example, a method in a parent Integrated Access and Backhaul (IAB) node that communicates over a radio interface, the method comprising: obtaining a switching time characteristic information for the child IAB node; generating radio resource configuration information to take into consideration a switching time characteristic of a child IAB node; transmitting the radio resource configuration information to the child IAB node.

In one example, a donor Access and Backhaul (IAB) node that communicates over a radio interface, the donor IAB node comprising: processor circuitry configured to generate radio resource configuration information for plural parent IAB nodes which serve one or more child IAB nodes in a case of a lack of correspondence between mobile termination entities and distributed units of the plural parent IAB nodes and the one or more child IAB nodes; transmitter circuitry configured to transmit the radio resource configuration information to the plural child IAB nodes.

In one example, the donor IAB node, wherein the radio resource configuration information indicates which radio resources are under control of each of the plural parent IAB nodes.

In one example, A method in donor Access and Backhaul (IAB) node that communicates over a radio interface, the method comprising: generating radio resource configuration information for plural parent IAB nodes which serve one or more child IAB nodes in a case of a lack of correspondence between mobile termination entities and distributed units of the plural parent IAB nodes and the one or more child IAB nodes; transmitting the radio resource configuration information to the plural child IAB nodes.

In one example, the method, wherein the radio resource configuration information indicates which radio resources are under control of each of the plural parent IAB nodes.

In one example, a child Integrated Access and Backhaul (IAB) node that communicates over a radio interface with a parent IAB node, the child IAB node comprising: receiver circuitry configured to receive radio resource configuration information from the parent node, the radio resource configuration information being configured to take into consideration a switching time characteristic of the child IAB node; processor circuitry configured to control wireless communications of the child IAB node in accordance with the radio resource configuration information.

In one example, the child IAB node, further comprising receiver circuitry, and wherein the transmitter circuitry and receiver circuitry are configured to perform wireless communications in consideration of the switching time characteristic of the child IAB node.

In one example, the child IAB node, wherein the radio resource configuration information explicitly indicates a character per resource type in each slot of the radio resource configuration indicated by the radio resource configuration information, the character being one of hard, soft, or not available, and the resource type being one of downlink, uplink, and flexible; and wherein the radio resource configuration information does not consider configuration or timing of a mobile termination unit of the child IAB node.

In one example, the child IAB node, wherein the switching time characteristic of the child IAB node comprises an indication of an amount of time required for hardware of the child IAB node to change between uplink transmission and downlink reception.

In one example, the child IAB node, wherein the indication of the amount of time required for the hardware of the child IAB node to change between the uplink transmission and the downlink reception is expressed as a number of slots or Orthogonal Frequency Division Multiplexing (OFDM) symbols.

In one example, the child IAB node, wherein the processor circuitry is configured to generate the switching time characteristic information, and wherein the child node further comprises transmitter circuitry configured to transmit the switching time characteristic information in a message to the parent IAB node.

In one example, the child IAB node, wherein the transmitter circuitry is configured to transmit the switching time characteristic information in an IAB node capability message from the child IAB node.

In one example, the child IAB node, wherein the resource configuration information assigns a first resource of a frame as a soft resource to the child IAB node does not allow the child IAB node to communicate in the first resource of the frame.

In one example, the child IAB node, wherein the resource configuration information does not schedule a transmission to the child IAB node if the transmission were to coincide with a transmission from the child IAB node.

In one example, the child IAB node, wherein the resource configuration information takes into consideration a timing gap between a first link and a second link, the first link being between the parent IAB node a mobile termination unit of the child node, the second link being between a distributed unit of the child IAB node and a further IAB node which is a child of the child IAB node.

In one example, the child IAB node, wherein the resource configuration explicitly indicates a character per resource type in each slot of the radio resource configuration, the character being one of hard, soft, or not available, and the resource type being one of downlink, uplink, and flexible; and wherein the processor circuitry is configured to allocate the character of the resource type in each slot relative to configuration slot timing of a mobile termination unit of the child IAB node.

In one example, the child IAB node, wherein the parent IAB node is a Donor IAB node, and wherein the transmitter circuitry is configured to transmit a signal indicating resources delegated to the child IAB node.

In one example, the child IAB node, wherein the resource configuration information reconfigures an association between a soft resource allocated to the distributed unit of the child IAB node and a flexible resource allocated to the mobile termination unit of the child IAB node.

In one example, the child IAB node, wherein the resource configuration information precludes assignment of a resource as a soft resource to a distributed unit of the child IAB node when the resource is always not available for a mobile termination unit of the 0020 child IAB node.

In one example, the child IAB node, wherein the resource configuration information selectively precludes assignment of the resource as a soft resource to the distributed unit of the child IAB node when the resource is always not available for the mobile termination unit of the child IAB node.

In one example, the child IAB node, wherein the resource configuration information indicates a character per resource type in each slot of the radio resource configuration, the character being one of hard, soft, or not available, and the resource type being one of downlink, uplink, and flexible; and wherein the processor circuitry is configured to apply a hard character relative to a DU resource configuration but implicitly indicate a soft character to be determined by the distributed unit of the child IAB node based on whether a corresponding MT configuration indicates the MT resource is F (DU-S).

In one example, the child IAB node, wherein the resource configuration information signals to the child IAB node an association between soft resources of a distributed unit of the child IAB node and flexible resource of a mobile termination unit of the child IAB node.

In one example, the child IAB node, wherein the resource configuration information signals to the child IAB node an association between soft resources of a distributed unit of the child IAB node and flexible resource of a mobile termination unit of the child IAB node.

In one example, a method in a child Integrated Access and Backhaul (IAB) node that communicates over a radio interface with a parent IAB node, the method comprising: receiving radio resource configuration information from the parent node, the radio resource configuration information being configured to take into consideration a switching time characteristic of the child IAB node; controlling wireless communications of the child IAB node in accordance with the radio resource configuration information.

In one example, the method, further comprising transmitting the switching time characteristic information of the child IAB node in a message to the parent IAB node.

In one example, a donor Access and Backhaul (IAB) node that communicates over a radio interface, the parent IAB node comprising: processor circuitry configured to generate radio resource configuration information for plural parent IAB nodes which serve one or more child IAB nodes in a case of a lack of correspondence between mobile termination entities and distributed units of the plural parent IAB nodes and the one or more child IAB nodes; transmitter circuitry configured to transmit the radio resource configuration information to the plural child IAB nodes.

In one example, the donor IAB node, wherein the radio resource configuration information indicates which radio resources are under control of each of the plural parent IAB nodes.

In one example, a parent Integrated Access and Backhaul (IAB) node that communicates over a radio interface, the parent IAB node comprising: processor circuitry configured to generate radio resource configuration information to take into consideration a switching time characteristic of a child IAB node; receiver circuitry configured to receive the capability of the switching time characteristic from the child IAB node; and transmitter circuitry configured to transmit the radio resource configuration information to the child IAB node.

In one example, the parent IAB node, wherein the processor circuitry is configured to explicitly indicate a character per resource type in each slot of the radio resource configuration indicated by the radio resource configuration information, the character being one of hard, soft, or not available, and the resource type being one of downlink, uplink, and flexible.

In one example, the parent IAB node, wherein in generating the radio resource configuration the processor circuitry is configured to assign a first resource as a soft distributed unit resource to the child IAB node, and to not allow the child IAB node to communicate in the first resource.

In one example, the parent IAB node, wherein the processor circuitry is configured to generate the radio resource configuration information to take into consideration a timing gap between a first link and a second link, the first link being between the parent IAB node a mobile termination unit of the child node, the second link being between a distributed unit of the child IAB node and a further IAB node which is a child of the child IAB node.

In one example, the parent IAB node, wherein the processor circuitry is configured to explicitly indicate a character per resource type in each slot of the radio resource configuration, the character being one of hard, soft, or not available, and the resource type being one of downlink, uplink, and flexible; and wherein the processor circuitry is configured to allocate the character of the resource type in each slot relative to configuration slot timing of a mobile termination unit of the child IAB node.

In one example, the parent IAB node, wherein the parent IAB node is a Donor IAB node, and wherein the receiver circuitry is configured to receive a signal indicating resources delegated to the child IAB node.

In one example, the parent IAB node, wherein the processor circuitry is configured to generate a signal to the child IAB node to reconfigure an association between a soft resource allocated to the distributed unit of the child IAB node and a flexible resource allocated to the mobile termination unit of the child IAB node.

In one example, the parent IAB node, wherein: the processor circuitry is configured to signal to the child IAB node an association between soft resources of a distributed unit of the child IAB node and flexible resource of a mobile termination unit of the child IAB node.

In one example, a method in a parent Integrated Access and Backhaul (IAB) node that communicates over a radio interface, the method comprising: obtaining a switching time characteristic information for the child IAB node; generating radio resource configuration information to take into consideration a switching time characteristic of a child IAB node; transmitting the radio resource configuration information to the child IAB node.

In one example, a child Integrated Access and Backhaul (IAB) node that communicates over a radio interface with a parent IAB node, the child IAB node comprising: transmitter circuitry configured to transmit a capability of a switching time characteristics; receiver circuitry configured to receive radio resource configuration information from the parent node, processor circuitry configured to control wireless communications of the child IAB node in accordance with the radio resource configuration information.

In one example, the child IAB node, wherein the radio resource configuration information explicitly indicates a character per resource type in each slot of the radio resource configuration indicated by the radio resource configuration information, the character being one of hard, soft, or not available, and the resource type being one of downlink, uplink, and flexible.

In one example, the child IAB node, wherein the resource configuration information does not schedule a transmission to the child IAB node if the transmission were to coincide with a transmission from the child IAB node.

In one example, a method in a child Integrated Access and Backhaul (IAB) node that communicates over a radio interface with a parent IAB node, the method comprising: receiving radio resource configuration information from the parent node, the radio resource configuration information being configured to take into consideration a switching time characteristic of the child IAB node; controlling wireless communications of the child IAB node in accordance with the radio resource configuration information.

<Cross Reference>

This Nonprovisional application claims priority under 35 U.S.C. § 119 on provisional Application No. 62,872,636 on Jul. 10 2019, the entire contents of which are hereby incorporated by reference.

What is claimed is:

1. A parent Integrated Access and Backhaul (IAB) node that communicates over a radio interface, the parent IAB node comprising:
processor circuitry configured to generate radio resource configuration information to take into consideration a switching time characteristic of a child IAB node;
receiver circuitry configured to receive the capability of the switching time characteristic from the child IAB node; and
transmitter circuitry configured to transmit the radio resource configuration information to the child IAB node.

2. The parent IAB node of claim 1, wherein the processor circuitry is configured to explicitly indicate a character per resource type in each slot of the radio resource configuration indicated by the radio resource configuration information, the character being one of hard, soft, or not available, and the resource type being one of downlink, uplink, and flexible.

3. The parent IAB node of claim 1, wherein in generating the radio resource configuration the processor circuitry is configured to assign a first resource as a soft distributed unit resource to the child IAB node, and to not allow the child IAB node to communicate in the first resource.

4. The parent IAB node of claim 1, wherein the processor circuitry is configured to generate the radio resource configuration information to take into consideration a timing gap between a first link and a second link, the first link being between the parent IAB node a mobile termination unit of the child node, the second link being between a distributed unit of the child IAB node and a further IAB node which is a child of the child IAB node.

5. The parent IAB node of claim 1, wherein the processor circuitry is configured to explicitly indicate a character per resource type in each slot of the radio resource configuration, the character being one of hard, soft, or not available, and the resource type being one of downlink, uplink, and flexible;
and wherein the processor circuitry is configured to allocate the character of the resource type in each slot relative to configuration slot timing of a mobile termination unit of the child IAB node.

6. The parent IAB node of claim 1, wherein the parent IAB node is a Donor IAB node, and wherein the receiver circuitry is configured to receive a signal indicating resources delegated to the child IAB node.

7. The parent IAB node of claim 1, wherein the processor circuitry is configured to generate a signal to the child IAB node to reconfigure an association between a soft resource allocated to the distributed unit of the child IAB node and a flexible resource allocated to the mobile termination unit of the child IAB node.

8. The parent IAB node of claim 1, wherein:
the processor circuitry is configured to signal to the child IAB node an association between soft resources of a distributed unit of the child IAB node and flexible resource of a mobile termination unit of the child IAB node.

9. A method in a parent Integrated Access and Backhaul (IAB) node that communicates over a radio interface, the method comprising:
obtaining a switching time characteristic information for the child IAB node;
generating radio resource configuration information to take into consideration a switching time characteristic of a child IAB node;
transmitting the radio resource configuration information to the child IAB node.

10. A child Integrated Access and Backhaul (IAB) node that communicates over a radio interface with a parent JAB node, the child JAB node comprising:
transmitter circuitry configured to transmit a capability of a switching time characteristics;
receiver circuitry configured to receive radio resource configuration information from the parent node,
processor circuitry configured to control wireless communications of the child JAB node in accordance with the radio resource configuration information.

11. The child IAB node of claim 10, wherein the radio resource configuration information explicitly indicates a character per resource type in each slot of the radio resource configuration indicated by the radio resource configuration information, the character being one of hard, soft, or not available, and the resource type being one of downlink, uplink, and flexible.

12. The child IAB node of claim 10, wherein the resource configuration information does not schedule a transmission to the child IAB node if the transmission were to coincide with a transmission from the child IAB node.

13. (canceled)
